(19) United States
(12) Patent Application Publication
(10) Pub. No.: US 2006/0165964 A1
(43) Pub. Date: Jul. 27, 2006

(54) High refractive index layer, production process of curable coating composition, antireflection film, polarizing plate and image display device using thereof

(76) Inventor: Eiichi Kato, Kanagawa (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/542,766

(22) PCT Filed: Mar. 5, 2004
(86) PCT No.: PCT/JP04/02929

§ 371 Date: Jul. 20, 2005

(30) Foreign Application Priority Data
Mar. 5, 2003 (JP) 2003-058579
Mar. 18, 2003 (JP) 2003-073962

(51) Int. Cl. B32B 7/02

(52) U.S. Cl. 428/212

(57) ABSTRACT

A high refractive index layer excellent in weatherability or optical properties and durability, an antireflection film having the layer, a polarizing plate having the antireflection film, and an image display device using thereof are provided, each of which is a high refractive index layer or film which contains specific fine particles of a high refractive index composite oxide containing a titanium element or a bismuth element; a production process of a curable coating composition which contains specific fine particles of a high refractive index composite oxide containing a bismuth element; an antireflection film using thereof; a polarizing plate and an image display device using thereof.

### TECHNICAL FIELD

The invention relates to a high refractive index layer, an antireflection film using the high refractive index layer, a polarizing plate and an image display device, and further relates to a production process of curable coating composition, a cured film, an antireflection film using the film, a polarizing plate and an image display device.

### BACKGROUND ART

A protective film (antireflection film) having an antireflection ability has heretofore been provided on a transparent substrate such as glass or plastic substrate used for lenses or image display devices. Especially, the antireflection film is disposed on the surface of displays used in various image display devices such as a liquid crystal display device (LCD), a plasma display panel (PDP), an electroluminescence display (ELD), and cathode ray tube display device (CRT) so as to prevent reduction in contrast due to reflection of outer light or outer image. Thus, the antireflection film is required to have a high physical strength (e.g., scratching resistance), chemical resistance, and weatherability (e.g., resistance to moist heat and resistance to light). Also, as an antireflection film for image display, there has been required an antireflection film having a high refractive index layer which has a higher refractive index than that of antireflection film for synthetic resin lens and which is colorless and transparent.

In recent years, liquid crystal display devices (LCD) have become large-sized, and liquid crystal display devices equipped with an antireflection film are being increased in number.

Also, in liquid crystal display devices (LCD), a polarizing plate is an indispensable member and generally has a structure wherein a polarizing film is protected by two protective films. To provide the protective films with the antireflection ability enables to greatly reduce production cost and thickness of the display device.

The antireflection film is generally formed of a multi-layer film composed of a plurality of metal oxide-containing transparent and thin layers laminated one over the other and different from each other in refractive index (such as a high refractive index layer, a middle refractive index layer and a low refractive index layer). The transparent thin films of metal oxide are formed by a chemical vapor deposition (CVD) method, a physical vapor deposition (PVD) method or a vacuum vapor deposition method which is a kind of physical vapor deposition method. Or, it has also been proposed to form the thin film by forming a colloidal metal oxide particle film according to a sol-gel process using a metal compound such as a metal alkoxide, followed by after-treatment (UV ray irradiation; see JP-A-9-157855; plasma treatment: see JP-A-2000-9908).

However, the above-described methods for forming the transparent thin film of metal oxide are poor in productivity and are not appropriate for mass production. Thus, there has been expected a method of forming the thin film by coating technique having a high productivity.

In the case of preparing an antireflection film by coating, a binder resin is used as a matrix for forming a film. Such binder resin usually has a refractive index of 1.45 to 1.55, and hence refractive index of each layer is properly adjusted by selecting the kind and amount of inorganic particles to be used therein. In particular, with a high refractive index layer, inorganic fine particles having a high refractive index are necessary, and it is of extreme importance to disperse, uniformly without agglomeration, fine inorganic particles having a high refractive index in a matrix having an enough film strength.

As inorganic fine particles having a high refractive index, there have been known fine particles of transparent single metal (e.g., Ti, Zn, Sb, Sn, Zr, Ce, Ta, La or In) oxide having a refractivity index of 1.7 or more (e.g., JP-A-8-110401 and JP-A-8-122504; the term “JP-A” as used herein means an “unexamined published Japanese patent application). It has also been proposed to form a high refractive index layer by introducing the high refractive inorganic fine particles in a more amount into the thin film with keeping the high refractive inorganic fine particles in a finely dispersed state (see, for example, JP-A-11-153703 and JP-A-2001-166104). Of these, titanium dioxide is a compound having an extremely high refractive index, and it is extremely effective to introduce the compound as fine particles (e.g., JP-A-2000-9908 and JP-A-2001-310423). However, titanium dioxide has a photo catalytic ability and has a seriously poor weatherability. Hence, when a high refractive index film (antireflection film) is used for a long period of time under sunlight, it decomposes organic compounds contained in the high refractive index film and seriously deteriorates physical strength and optical performance of the film, thus such film having involved problem with respect to durability of the film. For this problem, there has been proposed a technique of covering the surface of titanium oxide particles with other metal compound to provide fine particles of laminate structure for the purpose of improving weatherability (e.g., JP-A-2001-166104 and JP-A-2000-204301).

On the other hand, various composite metal oxides comprising a plurality of elements selected from among the aforesaid metal elements, Si, Al, Fe, W, etc. (double oxides) have also been proposed (e.g., JP-A-8-234001, JP-A-10-306258 and JP-A-11-140207). In particular, among them are disclosed high refractive index films containing a highly composite oxide containing titanium. For example, there have been proposed composite metal oxides such as a composite metal oxide of titanium oxide-cerium oxide-silicon oxide (JP-A-2000-204301), a composite oxide of titanium oxide-zirconium oxide-tin oxide (JP-A-8-113760) and a composite oxide of stannic oxide-titanium oxide (JP-A-10-306258).

Also, there has been proposed a technique of improving dispersibility of the particles and film properties as composite oxides containing Si, Al, etc. together with the above-described highly refractive metal elements (see, for example, JP-A-9-21901, JP-A-11-140207 and JP-A-2002-30250).

However, such titanium-containing composite oxides suffer reduction in resistance to light, though they can maintain the refractive index at a higher level with an increased content of titanium oxide having a high refractive index. In addition, the above-described techniques are still insufficient to design a high refractive thin film using a matrix in an enough amount to maintain sufficient film strength and resistance to embrittlement.

Thus, it has been required to prepare a high refractive index film excellent in weatherability (particularly, resistance to light) and film strength (e.g., resistance to brittleness, hardness and adhesion). However, such requirement has not yet been fully met. On the other hand, a composite oxide of titanium oxide and bismuth oxide has been proposed as a metal oxide coating for enhancing light-emitting efficiency of a yellow thermal electric-light bulb (JP-A-7-281023) However, it is not disclosed therein whether the composite oxide can be used as a colorless transparent film for a coating type antireflection film.

### DISCLOSURE OF THE INVENTION

An object of the invention is to provide a high refractive index layer excellent in weatherability.

Further object of the invention is to provide an antireflection film excellent in weatherability which can be inexpensively provided on a large scale.

Anther object of the invention is to provide a process for producing a curable coating composition excellent in optical properties and durability.

Further object of the invention is to provide a cured film excellent in optical properties and weatherability.

Further object of the invention is to provide an antireflection film excellent in optical properties and durability which can be inexpensively provided on a large scale.

Still further object of the invention is to provide a polarizing plate having been subjected to an antireflection properties-imparting treatment through appropriate means and an image display device.

The above-described problems can be solved by the present invention of the following constitution.

1. A high refractive index layer comprising a matrix and fine particles of a high refractive index composite oxide,

wherein the fine particles of a high refractive index composite oxide are fine particles of a composite oxide containing: a titanium element; and at least one metal element, in which the oxide of the at least one metal element has a refractive index of 1.95 or more, and

the composite oxide is doped with at least one metal ion selected from the group consisting of Co ion, Zr ion and Al ion.

2. The high refractive index layer as described in the item 1, wherein the fine particles of a high refractive index composite oxide are surface-treated with at least one compound selected from an inorganic compound and an organic compound.

3. The high refractive index layer as described in the item 1 or 2, wherein the matrix containes a cured product of at least one member selected from the group consisting of an organic binder, an organometallic compound and a partial hydrolyzate thereof.

4. The high refractive index layer as described in any one of the items 1 to 3, which has a refractive index of 1.75 to 2.4.

5. The high refractive index layer as described in any one of the items 1 to 4, which is formed from a composition obtained by dispersing particles of the high refractive index composite oxide using a dispersing agent, in which the dispersing agent is a compound having at least one anionic group selected from the group consisting of a carboxyl group, a sulfo group, a phosphono group and an oxyphosphono group.

6. The high refractive index layer as described in the item 5, wherein the dispersing agent is a compound containing a cross-linkable or polymerizable functional group.

7. An antireflection film comprising: a transparent support; the high refractive index layer described in any one of the items 1 to 6; and a low refractive index layer having a refractive index of less than 1.55, in this order.

8. An antireflection film comprising a transparent support; two layers of the high refractive index layers described in any one of the items 1 to 6 and different from each other in refractive index; and a low refractive index layer having a refractive index of less than 1.55, in this order.

9. The antireflection film as described in the item 7 or 8, which further comprises a hard coat layer between the transparent support and the high refractive index layer.

10. A polarizing plate comprising a polarizing film and a protective film thereof, wherein the protective film is the antireflection film described in any one of the items 7 to 9.

11. A polarizing plate comprising a polarizing film and protective films thereof, wherein one of the protective films is the antireflection film described in any one of claims 7 to 9, and the other protective film is an optically compensation film having an optical anisotropy.

12. The polarizing plate as described in the item 11, wherein said optically compensation film comprises a transparent support and an optically compensation layer including an optically anisotropic layer, the optically anisotropic layer containing a compound having a discotic structural unit, in which the disc plane of the discotic structural unit is inclined to the transparent support plane, and the angle between the disc plane and the transparent support plane is varied in the depth direction of the optically anisotropic layer.

13. An image display device comprising, on the image display surface, the antireflection film described in any one of the items 7 to 9 or the polarizing plate described in any one of the items 10 to 12.

14. A process for producing a curable coating composition comprising a film-forming curable compound and fine particles of a high refractive index composite oxide, in which the fine particles of a high refractive index composite oxide contains: a bismuth element; and at least one metal element, in which the oxides of the at least one metal element has a refractive index of 1.95 or more,

wherein the process comprises wet-dispersing particles of the high refractive index composite oxide and a dispersing agent using media having an average particle size of less than 1 mm to thereby produce fine particles of high refractive index composite oxide having an average particle size of 150 nm or less.

15. The process as described in the item 14, wherein said dispersing agent is a polymer dispersing agent having a polar group.

16. The process as described in the item 15, wherein said polar group is an at least one anionic group selected from the group consisting of a carboxyl group, a sulfo group, a phosphono group and oxyphosphono group.

17. The process as described in the item 15 or 16, wherein said dispersing agent is a compound having a cross-linkable or polymerizable functional group.

18. The process as described in any one of the items 14 to 17, wherein said film-forming curable compound is at least one of a curable organic binder, an organometallic compound and a partial hydrolyzate thereof.

19. A cured film which has a refractive index of 1.85 to 2.5 and is formed from a curable coating composition containing a film-forming curable compound and fine particles of a high refractive index composite oxide having an average particle size of 100 nm or less, the fine particles of a high refractive index composite oxide containing: a bismuth element; and at least one metal element, in which the oxide of the at least one metal element has a refractive index of 1.95 or more.

20. An antireflection film comprising: a transparent support; the cured film described in the item 19; and a low refractive index layer having a refractive index of less than 1.55, in this order.

21. An antireflection film comprising: a transparent support; two layers of the cured films described in the item 19 and different from each other in refractive index; and a low refractive index layer having a refractive index of less than 1.55, in this order.

22. The antireflection film as described in the item 20 or 21, which further comprises a hard coat layer between the transparent support and the cured film.

23. A polarizing plate comprising a polarizing film and a protective film thereof, wherein the protective film is the antireflection film described in any one of the items 20 to 22.

24. A polarizing plate comprising a polarizing film and protective films thereof, wherein one of the protective films is the antireflection film described in any one of the items 20 to 22 and the other protective film is an optically compensation film having an optical anisotropy.

25. The polarizing plate as described in the item 24, wherein said optically compensation film comprises a transparent support and an optically compensation layer including an optically anisotropic layer, the optically anisotropic layer containing a compound having a discotic structural unit, in which the disc plane of the discotic structural unit is inclined to the transparent support plane, and the angle between the disc plane and the transparent support plane is varied in the depth direction of the optically anisotropic layer.

26. An image display device comprising, on the image display surface, the antireflection film described in any one of the items 20 to 22 or the polarizing plate described in any one of the items 23 to 25.

27. The image display device comprising the antireflection film described in any one of the items 20 to 22 or the polarizing plate described in any one of the items 23 to 25, wherein the polarizing plate is a polarizing plate on the display side of two polarizing plates provided on both sides of a liquid crystal cell, and the antireflection film is disposed at the side opposite to the liquid crystal cell.

28. The image display device as described in the item 26 or 27, which is a transmission type, reflection type or semi-transmission type liquid crystal display device, each of which is a TN-, STN-, IPS-, VA- or OCB-mode.

### BEST MODES OF CARRYING OUT THE INVENTION

The invention is described in more detail below.

Firstly, the present invention relating to the high refractive index layer is described in more detail below.

[High Refractive Index Layer]

The high refractive index layer of the invention contains fine particles of a composite oxide of titanium and at least one metal element the oxide of which has a refractive index of 1.95 or more, and a matrix.

The high refractive index layer of the invention has a refractive index of preferably 1.75 to 2.40, more preferably 1.80 to 2.40, still more preferably 1.85 to 2.30.

(Fine Particles of a High Refractive Index Composite Oxide)

The high refractive index fine particles of a composite oxide in the invention are described below.

The fine particles of a composite oxide in accordance with the invention are particles of a composite oxide of a titanium element and at least one metal element (hereinafter also abbreviated as “Met”) selected from those metal elements the oxides of which have a refractive index of 1.95 or more, with the composite oxide being doped with at least one metal ion selected from among Co ion, Zr ion and Al ion. As the metal elements the oxides of which has a refractive index of 1.95 or more, Ta, Zr, In, Nd, Sb, Sn and Bi are preferred, with Ta, Zr, Sn and Bi being particularly preferred.

The proportion of Ti element in the composite oxide fine particles is preferably 0.6 to 0.99 by weight ratio in terms of titanium dioxide (TiO₂), more preferably 0.7 to 0.95 by weigh ratio, still more preferably 0.75 to 0.90 by weight ratio.

The fine particles of the composite oxide preferably has a crystalline structure such as rutile structure, rutil/anatase mixed crystal structure, anatase structure or an amourphous structure. The major component of the particles is particularly of the rutil structure.

The particles of the composite oxide are particles of a composite oxide doped with at least one metal ion selected from among Co ion, Zr ion and Al ion. As the metal ion to be doped, Co ion and Zr ion are referred, with Co ion being particularly preferred.

In view of maintaining the level of refractive index, the content of the metal ion to be doped in the composite oxide is preferably in a range not exceeding 25% by weight based on the amount of whole metals [Ti+Met] constituting the composite oxide. The content is more preferably 0.05 to 10% by weight, still more preferably 0.1 to 5% by weight, most preferably 0.3 to 3% by weight.

The doped ion may exist in any form of metal ion and meta atom and properly exist from the surface of the composite oxide to the interior thereof. It is preferred for the metal ion to exist in both the surface and the interior thereof.

When doped with the metal ion in an amount of the above-mentioned range, the resultant high refractive index fine particles of the composite oxide can acquire a good transparency in a range of from 380 nm to 600 nm and a high refractive index, with the undesirable photo-catalytic activity being remarkably depressed or removed. The refractive index of the particles can be adjusted in a range of from 1.98 to 2.60, and it is preferred to adjust the refractive index within a range of from 2.00 to 2.55.

The weight-average particle size of primary particles of the high refractive index fine particles of the composite oxide is in a range of preferably from 1 to 200 nm, more preferably from 3 to 150 nm, still more preferably 5 to 100 nm, particularly preferably from 10 to 80 nm.

The particle size of the fine particles can be measured according to the light scattering method or from an electron microscopic photograph. The specific surface area of the fine particles is preferably 15 to 400 m²/g, more preferably 20 to 200 m²/g.

The high refractive index composite oxide fine particles in accordance with the invention may further contain other elements according to the end purpose within a range of not sacrificing refractive index and transparency. The other elements may be contained as impurities, thus not being particularly limited. Examples of the other elements include Li, Be, B, Na, Mg, Si, K, Ca, Sc, V, Cr, Mn, Fe, Ni, Cu, Zn, Ga, Ge, Rb, Sr, Y, Mo, Cs, Ba, La, Hf, W, Tl, Pb, Ce, Pr, Nd, Pm, Sm, Eu, Gd, Tb, Dy, Ho, Er, Tm, Yb, etc. For example, incorporation of Si to form a ternary composite oxide serves to make the particles finer and improve dispersibility of the particles.

The high refractive index composite oxide may be synthesized according to conventionally known sintering process, sol-gel process, sputtering process or CVD process. For example, reference may be made to the descriptions given in Kinzoku Sankabutsu To Fukugo Sankabutsu compiled by Kozo Tabe et al (published by Kabushikikaisha Kodansha in 1978); Jpn. J. Appl. Phys. Vol. 32, pp. 4158-4162 (1993); JP-A-11-71103; JP-A-11-228139; JP-A-11-79746; and JP-A-2002-206062.

As a method for doping the composite oxide with a dopant of Co ion, Al ion or Zr ion, conventionally known methods may be employed. For example, the doped oxide can be produced according to the ion-injecting method (described in, e.g., Ion Beam Oyo Gijutsu compiled by Shun-ichi Gonda, Junzo isikawa and Eiji Kamijo, and published by K.K. CMC in 1989; Yasushi Aoki, HyomenKagaku, Vol. 18, (5), pp. 262, 1998; and Hyomen Kagaku Vol. 20 (2), pp. 60, 1999) or a method described in JP-A-5-330825, JP-A-11-263620, JP-T-11-512336 (the term “JP-T” as used herein means a published Japanese translation of a PCT patent application) or EP-A-0335773.

The high refractive index fine particles of composite oxide fine particles in accordance with the invention may be subjected to surface treatment. Such surface treatment may be conducted by modifying the particle surface using at least one compound selected from among inorganic compounds and organic compounds, which serves to adjust wetting properties of the particle surface for making the particles finer in an organic solvent and improving dispersibility or dispersion stability in the high refractive index layer-forming composition. Examples of the inorganic compounds to be used for the surface treatment include cobalt-containing inorganic compounds (e.g., CoO₂, Co₂O₃ and Co₃O₄), aluminum-containing compounds (e.g., Al₂O₃ and Al (OH)₃), zirconium-containing inorganic compounds (e.g., ZrO₂ and Zr(OH)₄), and silicon-containing inorganic compounds (e.g., SiO₂).

As the organic compounds to be used for the surface treatment, there may be used conventionally known surface-modifying agents for inorganic fillers such as metal oxides or inorganic pigments. For example, they are described in Ganryo Bunsan Anteika To Hyomen Shori Gijutsu Hyoka, Chapter 1 (published by Gijutsu Joho Kyokai in 2001).

More specifically, there are illustrated organic compounds having a polar group which has affinity for the surface of high refractive index composite oxide fine particles, and coupling compounds. Examples of the polar group having affinity for the surface of high refractive index composite oxide fine particles include a carboxy group, a phosphono group, a hydroxyl group, a mercapto group, a cyclic acid anhydride group and an amino group. Compounds having at least one polar group within the molecule are preferred. Examples thereof include long-chain aliphatic carboxylic acids (e.g., stearic acid, lauric acid, oleic acid, linoleic acid, linolenic acid, etc.), polyol compounds (e.g., pentaerythritol triacrylate, dipentaerythritol pentaacrylate, ECH-modified glycerol triacrylate, etc.), phosphono group-containing compounds (e.g., EO (ethylene oxide)-modified phosphoric acid triacrylate, etc.), alkanolamines (e.g., ethylenediamine EO adduct (5 mols), etc.)

As the coupling compound, there are illustrated conventionally known organometallic compounds including silane coupling agents, titanate coupling agents and aluminate coupling agents. Silane coupling agents are most preferred. Specifically, there are illustrated, for example, those compounds which are described in JP-A-2002-9908 and JP-A-2001-31-423, paragraphs [0011] to [0015].

The above-described compounds to be used for the surface treatment may be used in combination of two or more thereof. In order to impart hydrophobic properties by subjecting the surface of the high refractive index composite oxide fine particles to the surface treatment with an organic compound and/or an organometallic compound, the polar group-having organic compound and/or the organometallic compound is dissolved in an organic solvent, and the high refractive index composite oxide fine particles having or not having been subjected to surface treatment with an inorganic compound is dispersed in the solution, followed by completely evaporating away the organic solvent, thus the particle surface being coated.

The composite oxide fine particles of the invention may be used as fine particles of a core/shell structure wherein the particles constitute a core having a shell comprising an inorganic compound. As the shell, an oxide comprising at least one element selected from among Al, Si and Zr is preferred. Specifically, there are illustrated, for example, descriptions given in JP-A-2001-166104.

The shape of the fine particles of the high refractive index composite oxide to be contained in the high refractive index layer is not particularly limited, and there may be illustrated a rice grain-like shape, a spherical shape, a cubic shape, a spindle-like shape, a needle-like shape and an indefinite shape.

(Dispersion of the Fine Particles of High Refractive Index Composite Oxide)

The high refractive index layer of the invention is formed preferably by dispersing the high refractive index composite oxide particles using a dispersing agent to prepare a composition for forming the high refractive index layer, and coating it on a transparent support or other layer, followed by drying.

The dispersing agent to be used for dispersing the high refractive index composite oxide fine particles is preferably a low molecular compound or a polymer compound having a polar group having affinity for the surface of the composite oxide fine particles.

Examples of the polar group include a hydroxy group, a mercapto group, a carboxyl group, a sulfo group, a phosphono group, an oxyphosphono group, —P(═O)(R)(OH) group, a —O—P(—O) (R) (OH) group, a sulfonamido group, a cyclic acid anhydride-containing group, an amino group and a quaternary ammonium group. In the above-described groups, R represents a hydrocarbonic group containing 1 to 18 carbon atoms (e.g., a methyl group, an ethyl group, a propyl group, a butyl group, a hexyl group, an octyl group, a decyl group, a dodecyl group, an octadecyl group, a benzyl group, a phenethyl group, and a cyclohexyl group). Of the polar groups, those groups having a dissociative proton may be in the salt form. The amino group and the quaternary ammonium group may be any of a primary amino group, a secondary amino group and a tertiary amino group, with a tertiary amino group or a quaternary ammonium group being more preferred. The group bound to the nitrogen atom in the secondary amino group, tertiary amino group or quaternary ammonium group is preferably an aliphatic group containing 1 to 12 carbon atoms (e.g., the same as referred to with respect to R described above). Also, the tertiary amino group may be an amino group forming a nitrogen-containing ring (e.g., a piperidine ring, a morpholine ring, a piperadine ring or a pyridine ring) and, further, the quaternary ammonium group may be a quaternary ammonium group of such cyclic amino group. In particular, those which have an alkyl group containing 1 to 6 carbon atoms are more preferred.

As the counter ion for the quaternary ammonium group, halide ion, PF₆ ion, SbF₆ ion, BF₄ ion, sulfonate ion, etc. are preferred.

The polar group is preferably an anionic group. In particular, a carboxyl group, a sulfo group, a phosphono group, an oxyphosphono group and the salts of these groups are preferred, with a carboxyl group, a phosphono group and an oxyphosphono group being still more preferred.

The dispersing agent may have plural kinds of polar groups within the molecule.

The dispersing agent has more preferably a cross-linkable or polymerizable functional group. The term “cross-linkable or polymerizable functional group” as used herein means a functional group which can polymerize to form a polymer and which can cross-link polymer chains to each other through a polymer chain.

Examples of the cross-linkable or polymerizable functional group include an ethylenically unsaturated group capable of undergoing addition reaction or polymerization reaction with a radical species (e.g., a (meth)acryloyl group, an allyl group, a styryl group or a vinyloxycarbonyl group or a vinyloxy group), a cation-polymerizable group (e.g., an epoxy group, a thioepoxy group, an oxetanyl group, a vinyloxy group or a spiroorthoester group), and a polycondensation-reactive group (e.g., a hydrolysable silyl group or an N-methylol group), with an ethylenically unsaturated group and an epoxy group being preferred.

Specifically, there are illustrated, for example, those which are described in JP-A-2001-310423, paragraphs [0013] to [0015], though the compounds of the invention are not limited only to them.

As the dispersing agent to be used for dispersing fine particles of the high refractive index composite oxide for used in the high refractive index layer of the invention, polymer dispersing agents are preferred as well. In particular, polymer dispersing agents having an anionic group and having a cross-linkable or polymerizable functional group are preferred.

The weight-average molecular weight (Mw) of the polymer dispersing agents are not particularly limited, but is preferably 1×10³ or more. The Mw is more preferably 2×10³ to 1×10⁶, still more preferably 5×10³ to 2×10⁵, particularly preferably 1×10⁴ to 1×10⁵.

The polar group and the cross-linkable or polymerizable functional group in the polymer dispersing agent are contained at the end of the main chain of the polymer or as a substituent in the side chain of a polymer-forming unit (hereinafter also referred to as “side chain”). Those polymer dispersing agents are preferred wherein the polar group is bound to the end of the polymer main chain and/or to the side chain, and the cross-linkable or polymerizable functional group is bound to the side chain. As techniques for introducing the polar group into the side chain, there are, for example, a technique of polymerizing an anionic group-containing monomer (e.g., (meth)acrylic acid, maleic acid, partially esterified maleic acid, itaconic acid, crotonic acid, 2-carboxyethyl (meth)acrylate, 2-sulfoethyl(meth)acrylate, 2-phosphonoxyethyl(meth)acrylate, 2,3-dihydroxypropyl (meth)acrylate, 2-N,N-dimethylaminoethyl(meth)acrylate, or (meth)acryloyloxyethyltrimethylammonium•PF₆ ion salt, and a technique of utilizing polymer reaction of acting an acid anhydride on a polymer having a hydroxyl group or an amino group.

In the polymer dispersing agent having the polar group in the side chain, the content of the polymerization unit containing the polar group is in a range of preferably from 0.1 to 100% by weight, more preferably from 1 to 80% by weight, particularly preferably from 5 to 50% by weight, based on the weight of the total polymerization units.

On the other hand, as techniques for introducing the polar group into an end of the main chain, there are a technique of conducting polymerization reaction in the presence of a polar group-containing chain transfer agent (e.g., thioglycollic acid), a technique of conducting polymerization reaction using a polar group-containing initiator (e.g., V-501 made by Wako Pure Chemical Industries, Ltd.) and a technique of conducting polymerization reaction using a chain transfer agent or a polymerization initiator having a reactive group such as a halogen atom, a hydroxyl group or an amino group, then introducing the polar group through polymer reaction.

Particularly preferred dispersions are the dispersions having an anionic group in the side chain thereof.

As the cross-linkable or polymerizable functional group, there are illustrated an ethylenically unsaturated group capable of undergoing addition reaction or polymerization reaction with a radical species (e.g., a (meth)acryloyl group, an allyl group, a styryl group or a vinyloxy group), a cation-polymerizable group (e.g., an epoxy group, an oxetanyl group or a vinyloxy group), and a polycondensation-reactive group (e.g., a hydrolysable silyl group or an N-methylol group), with an ethylenically unsaturated group being preferred. Also, with these cross-linkable or polymerizable functional groups, the total number of atoms (excluding hydrogen atoms bound to carbon atom, nitrogen atom, silicon atom and the like) between the polymer main chain and the cross-linkable or polymerizable group is preferably 6 or more, more preferably 8 to 22, whereby the cross-linking or polymerization reaction proceeds more smoothly.

The dispersing agent in accordance with the invention has a polymerization unit having an ethylenically unsaturated group in the side chain as the cross-linkable or polymerizable functional group. As examples of the polymerization unit having an ethylenically unsaturated group in the side chain, there can be utilized polymerization unit of poly-1,2-butadiene or poly-1,2-isoprene structure, or a polymerization unit of (meth)acrylic acid ester or amide to which a specific residue (R group in —COOR or —CONHR) is bound. Examples of the specific residue (R) include —(CH₂)ₙ—CR₁═CR₂R₃, —(CH₂O)n-CH₂CR₁═CR₂R₃, —(CH₂CH₂O)n-CH₂CR₁═CR₂R₃, —(CH₂)n-NH—CO—O—CH₂CR₁═CR₂R₃, —(CH₂)n-O—CO—R₁═CR₂R₃ and —(CH₂CH₂O)₂—X (wherein R₁ to R₃ each represents a hydrogen atom, a halogen atom (e.g., a fluorine atom or a chlorine atom), an alkyl group containing 1 to 20 carbon atoms, an aryl group, an alkoxy group, an aryloxy group or a cyano group, R₁ and R₂ or R₃ are optionally bound to each other to form a ring, n represents an integer of 1 to 10, and X represents a dicyclopentadienyl residue). Examples of the specific residue in the ester moiety include —CH₂CH═CH₂ (corresponding to the polymer of allyl(meth)acrylate described in JP-A-64-17047), —CH₂CH₂O—CH₂CH═CH₂, —CH₂CH₂OCOCH═CH₂, —CH₂CH₂OCOC(CH₃)═CH₂, —CH₂C(CH₃)═CH₂, —CH₂CH═CH—C₆H₅, —CH₂CH₂OCOCH═CH—C₆H₅, —CH₂CH₂—NHCOO—CH₂CH═CH₂ and —CH₂CH₂O—X (wherein X represents a dicyclopentadienyl residue). Examples of the specific residues in the amido moiety include —CH₂CH═CH₂, —CH₂CH₂—Y (wherein Y represents a 1-cyclohexenyl residue), —CH₂CH₂—OCO—CH═CH₂, and —CH₂CH₂—OCO—C(CH₃)═CH₂.

With the dispersing agent having the ethylenically unsaturated group, curing occurs when a free radical (a polymerization-initiating radical or a growing radical produced in the course of polymerization of a polymerizable compound) adds to the unsaturated bond group to cause addition polymerization between molecules directly or via a polymer chain of the polymerizable compound. Or, curing occurs when an atom in the molecule (e.g., a hydrogen atom on the carbon atom adjacent to the unsaturated bond) is withdrawn by a free radical to produce polymer radicals, and the polymer radicals are then bound to each other to form a cross-linkage between the molecules.

As techniques for introducing the cross-linkable or polymerizable functional group into the side chain, reference may be made to the descriptions given in, for example, JP-A-3-249653. As to the content of the unit having the cross-linkable or polymerizable functional group, the unit may constitute all polymerization units other than the polar group-containing polymerization units, and the content of the cross-linkable or polymerizable group-containing unit is preferably 1 to 80% by weight, particularly preferably 3 to 60% by weight, based on the whole polymerization units of the dispersing agent.

The dispersing agent in accordance with the invention may be a copolymer of a polar group-containing polymeriable component, a cross-linkable or polymerizable functional group-containing polymerizable component and other polymerizable component. The other copolymerizable component is not particularly limited, and is selected in various points of view such as dispersion stability, compatibility with other monomer components and strength of formed film. Preferred examples thereof include methacrylates, acrylates, vinyl carboxylates, (meth)acrylamide and the derivatives thereof, styrene and its derivatives, and acrylonitrile.

The dispersing agent in accordance with the invention is not particularly limited as to polymerization form, but block copolymers or random copolymers are preferred. In view of production cost and ease of synthesis, random copolymers are particularly preferred.

Preferred specific examples of these dispersing agents are described in, for example, JP-A-11-153703, paragraphs [00023] to [0042].

The amount of the dispersing agent for the fine particles of high refractive index composite oxide is in a range of preferably from 1 to 50% by weight, more preferably from 5 to 30% by weight, most preferably from 5 to 20% by weight. Two or more of the dispersing agents may be used in combination.

It is preferred to disperse the fine particles of the high refractive index composite oxide by dispersing the fine particles in a dispersing medium in the presence of the above-described dispersing agent.

As the dispersing medium, liquids having a boiling point of from 60 to 170° C. are preferably used.

Examples of the dispersing medium include water, alcohols (e.g., methanol, ethanol, isopropanol, butanol, and benzyl alcohol), ketones (e.g., acetone, methyl ethyl ketone, methyl isobutylo ketone, and cyclohexanone), esters (e.g., methyl acetate, ethyl acetate, propyl acetate, butyl acetate, methyl formate, ethyl formate, propyl formate, and butyl formate), halogenated hydrocarbons (e.g., methylene chloride, chloroform or methylchloroform), aromatic hydrocarbons (e.g., benzene, toluene, and xylene), amides (e.g., dimethylformamide, dimethylacetamide, and n-methylpyrrolidone), ethers (e.g., diethyl ether, dioxane, tetrahydjrofuran, and ethylene glycol dimethyl ether), and ether alcohols (e.g., 1-methoxy-2-propanol, ethyl cellosolve, and methylcarbinol). These may be used alone or in combination of two or more of them. Preferred dispersing media include toluene, xylene, methyl ethyl ketone, methyl isobutyl ketone, cyclohexanone, and butanol.

It is preferred to disperse the fine particles of the high refractive index composite oxide using a dispersing machine. Examples of the dispersing machine include a sand grinder mill (e.g., a pinned beads mill), a high-speed impeller mill, a pebble mill, a roller mill, an attritor, and a colloid mill. In particular, a sand grainder mill and a high-speed impeller mill are preferred. Also, a preliminary dispersing treatment may be conducted. Examples of a dispersing machine to be used for the preliminary dispersing treatment include a ball mill, a three-roll mill, a kneader and an extruder.

The fine particles of the high refractive index composite oxide are preferably dispersed as finely as possible in the dispersing medium, and the weight-average particle size is preferably 1 to 200 nm, more preferably 3 to 150 nm, still more preferably 5 to 100 nm, particularly preferably 10 to 80 nm.

A high refractive index layer can be formed without spoiling transparency, by making the fine particles of the high refractive index composite oxide as fine as 200 nm or less.

The content of the fine particles of the high refractive index composite oxide is preferably 10 to 90% by weight, more preferably 15 to 80% by weight, particularly preferably 15 to 75% by weight, based on the weight of the high refractive index layer. Two or more kinds of the fine particles of the high refractive index composite oxide may be used within the high refractive index layer.

After completion of the dispersing treatment, the fine particles of the high refractive index composite oxide are used as a dispersion also containing the dispersing agent for preparing a coating solution for forming the high refractive index layer.

Secondly, the present invention relating to the production process of a curable coating composition is described in more detail below.

The process of the invention is a process for producing a curable coating composition containing at least fine partricles of a high refractive index composite oxide of a bismuth element and at least one metal element selected from those metal elements the oxides of which have a refractive index of 1.95 or more and a film-forming curable compound, which process comprises wet-dispersing the high refractive index composite oxide particles and a dispersing agent using media of less than 1 mm in average particle size to thereby produce high refractive index composite oxide fine particles of 150 nm or less in average particle size.

[Curable Coating Composition]

The curable coating composition in accordance with the invention contains at least fine particles of a high refractive index composite oxide of a bismuth element and at least one metal element selected from those metal elements the oxides of which have a refractive index of 1.95 or more, and a film-forming curable compound.

(High Refractive Index Composite Oxide Fine Particles)

The high refractive index composite oxide fine particles comprise composite oxide fine particles of bismuth element (Bi) and at least one metal element (hereinafter also abbreviated as “Met”) selected from those metal elements the oxides of which have a refractive index of 1.95 or more. As the metal elements the oxides of which has a refractive index of 1.95 or more, Ti, Ta, Zr, In, Nd, Sb and Sn are preferred, with Ti, Ta and Zr being more preferred.

Also, the proportion of Bi in the composite oxide fine particles is preferably 0.01 to 0.15 in terms of molar ratio [Bi/Bi+Met], more preferably 0.02 to 0.13, particularly preferably 0.03 to 0.10. The fine particles having the proportion within such range can give a cured film having a markedly high refractive index with maintaining a good transparency in a range of from 380 nm to 600 nm in wavelength.

The structure of the composite oxide fine particles is considered to be a single substance, mixture or amorphous substance of oxides of respective elements or composite oxides thereof. Although it is not clear which factor contributes to improvement of the refractive index, the composite oxide fine particles in accordance with the invention has a higher refractive index than that of Bi oxide (i.e., Bi₂O₃) or Met oxide (i.e., TiO₂, Ta₂O₅, ZrO₂, or the like) due to the presence of the model structure of Met-Bi-O. Also, the composite oxide fine particles preferably have a crystalline structure in view of obtaining a high refractive index.

The composite oxide fine particles in accordance with the invention may further contain other elements according to the end purpose within a range of not sacrificing refractive index and transparency, thus forming a multi-element composite oxide. The other elements may be contained as impurities, thus not being particularly limited. Examples of the other elements include Li, Be, B, Na, Mg, Al, Si, K, Ca, Sc, V, Cr, Mn, Fe, Co, Ni, Cu, Zn, Ga, Ge, Rb, Sr, Y, Mo, Sn, Sb, Cs, Ba, La, Hf, W, Tl, Pb, Ce, Pr, Nd, Pm, Sm, Eu, Gd, Tb, Dy, Ho, Er, Tm, Yb, etc. For example, incorporation of Si or Al serves to make the particles finer and improve dispersibility of the particles.

The composite oxide fine particles may be synthesized according to conventionally known sintering process, sol-gel process, sputtering process or CVD process. For example, reference may be made to the descriptions given in Kinzoku Sankabutsu To Fukugo Sankabutsu compiled by Kozo Tabe et al (published by Kabushikikaisha Kodansha in 1978); Jpn. J. Appl. Phys. Vol. 32, pp. 4158-4162 (1993); JP-A-11-71103; JP-A-11-228139; JP-A-11-79746; and JP-A-2002-206062.

The composite oxide particles in accordance with the invention may be subjected to surface treatment. Such surface treatment may be conducted by modifying the particle surface using an inorganic compound and/or an organic compound, and serves to adjust wetting properties of the particle surface for making the particles finer in an organic solvent and improving dispersibility or dispersion stability in the high refractive index layer-forming composition.

As the inorganic compound to be used for the surface treatment, there are illustrated those inorganic compounds which physicochemically adsorb onto the particle surface, and examples thereof include silicon-containing inorganic compounds (e.g., SiO₂), aluminum-containing inorganic compounds (e.g., Al₂O₃, Al(OH)₃, etc.), cobalt-containing inorganic compounds (e.g., CoO₂, Co₂O₃, Co₃O₄, etc.), zirconium-containing inorganic compounds (e.g., ZrO₂, Zr (OH)₄, etc.), and iron-containing inorganic compounds (e.g., Fe₂O₃).

As the organic compounds to be used for the surface treatment, there may be used conventionally known surface-modifying agents for inorganic fillers such as metal oxides or inorganic pigments. For example, they are described in Ganryo Bunsan Anteika To Hyomen Shori Gijutsu-Hyoka, Chapter 1 (published by Gijutsu Joho Kyokai in 2001).

More specifically, there are illustrated organic compounds as above-mentioned.

Also, the composite oxide fine particles of the invention may be doped with at least one metal ion selected from among Co ion, Zr ion and Al ion. In view of retaining the refractive index value, the content of the metal ion doped in the composite oxide is preferably in an amount of not exceeding 20% by weight based on the total weight of metals constituting the composite oxide. The content is more preferably 0.05 to 10% by weight, still more preferably 0.1 to 5% by weight, most preferably 0.3 to 3% by weight. The doped metal ion may exist in a state of either metal ion or metal atom, and may exist at any proper position of from the surface to the interior.

Doping of the composite oxide fine particles with the metal ion serves to obtain composite oxide fine particles having good resistance to light with maintaining the high refractive index. Of the above-described metal ions, Co ion is preferred for the doping.

As a method for doping the particles with the metal ion, conventionally known methods may be employed. For example, there may be employed an ion-injecting method (Ion Beam Oyo Kijutsu compiled by Shun-ichi Konta, Junzo Isikawa and Eiji Kamijo and published by Kabusiki Kaisha CMC in 1989; Yasushi Aoki, Hyomen Kagaku, Vol. 18(5), p 262, 1998; and Shoichi Abo, et al., Hyomen Kagaku, Vol. 20(2), p 60, 1999.

The content of the composite oxide fine particles in the curable coating composition is preferably 40 to 75% by weight, more preferably 45 to 65% by weight, based on the total weight of the curable coating composition. When incorporated in a content within this range, a cured film formed using the curable coating composition has a satisfactory film strength and a high refractive index. The composite oxide fine particles may be used in combination of two or more kinds thereof.

(Dispersing Agent)

The dispersing agent to be used in the production process of the invention is not particularly limited, but is preferably a small molecular compound or a polymer compound having a polar group having affinity for the surface of the composite oxide fine particles.

Examples of the polar group which the dispersing agent of the invention has include a hydroxyl group, a mercapto group, a carboxyl group, a sulfo group, a phosphono group, an oxyphosphono group, —P((═O) (R¹)(OH) group, an amido group (—CONHR², —SO₂NHR²), a cyclic acid anhydride-containing group, an amino group and a quaternary ammonium group. In the above-described groups, R¹ represents a hydrocarbonic group containing 1 to 18 carbon atoms (e.g., a methyl group, an ethyl group, a propyl group, a butyl group, a hexyl group, an oxtyl group, a decyl group, a dodecyl group, an octadecyl group, a chloroethyl group, a methoxyethyl group, a cyanoethyl group, a benzyl group, a methylbenzyl group, a phenethyl group, and a cyclohexyl group). Also, R² represents a hydrogen atom or the same group as with R¹.

Of the polar groups, those groups having a dissociative proton may be in the salt form.

Also, the amino group and the quaternary ammonium group may be any of a primary amino group, a secondary amino group and a tertiary amino group, with a tertiary amino group or a quaternary ammonium group being more preferred. The group bound to the nitrogen atom in the secondary amino group, tertiary amino group or quaternary ammonium group is preferably an aliphatic group containing 1 to 12 carbon atoms (e.g., the same as referred to with respect to R described above). Also, the tertiary amino group may be an amino group forming a nitrogen-containing ring (e.g., a piperidine ring, a morpholine ring, a piperadine ring or a pyridine ring) and, further, the quaternary ammonium group may be a quaternary ammonium group of such cyclic amino group. In particular, those which have an alkyl group containing 1 to 6 carbon atoms are more preferred.

As the counter ion for the quaternary ammonium group, halide ion, PF₆ ion, SbF₆ ion, BF₄ ion, B(R³)₄ ion (wherein R³ represents a hydrocarbonic group such as a butyl group, a phenyl group, a tolyl group, a naphthyl group or a butylphenyl group), sulfonate ion, etc.) are preferred.

The polar group is preferably an anionic group. In particular, a carboxyl group, a sulfo group, a phosphono group, an oxyphosphono group and the salts of these groups are preferred, with a carboxyl group, a phosphono group and an oxyphosphono group being still more preferred.

Also, the dispersing agent may have a plural kinds of polar groups within the molecule.

The dispersing agent has more preferably a cross-linkable or polymerizable functional group. Examples of the cross-linkable or polymerizable functional group include an ethylenically unsaturated group capable of undergoing addition reaction or polymerization reaction with a radical species (e.g., a (meth)acryloyl group, an allyl group, a styryl group, a vinyloxycarbonyl group or a vinyloxy group), a cation-polymerizable group (e.g., an epoxy group, a thioepoxy group, an oxetanyl group, a vinyloxy group or a spiroorthoester group), and a polycondensation-reactive group (e.g., a hydrolysable silyl group or an N-methylol group), with an ethylenically unsaturated group and an epoxy group being preferred.

Specifically, there are illustrated, for example, those which are described in JP-A-2001-310423, paragraphs [0013] to [0015].

As the dispersing agent in accordance with the invention, polymer dispersing agents are more preferred. In particular, polymer dispersing agents having an anionic group as the polar group and having a cross-linkable or polymerizable functional group are preferred.

The weight-average molecular weight (Mw) of the polymer dispersing agents are not particularly limited, but is preferably 1×10³ or more in terms of polystyrene measured according to GPC method. The Mw is more preferably 2×10³ to 1×10⁶, still more preferably 5×10³ to 1×10⁵, particularly preferably 8×10³ to 8×10⁴.

The polymer dispersing agents having Mw in this range functions to well disperse the fine particles and can provide a stable dispersion not forming agglomerate or precipitate.

The polar group and the cross-linkable or polymerizable functional group in the polymer dispersing agent are contained at the end of the main chain of the polymer or as a substituent in the side chain of a polymer-forming unit (hereinafter also referred to as “side chain”). The polar group is preferably bound to the end of the polymer main chain and/or to the side chain, and the cross-linkable or polymerizable functional group is preferably bound to the side chain.

As techniques for introducing the polar group into the end of the main chain, there are a technique of conducting polymerization reaction in the presence of a polar group-containing chain transfer agent (e.g., thioglycollic acid), a technique of conducting polymerization reaction using a polar group-containing initiator (e.g., V-5-1 made by Wako Pure Chemical Industries, Ltd.) and a technique of conducting polymerization reaction using a chain transfer agent or a polymerizaqtion initiator having a reactive group such as a halogen atom, a hydroxyl group or an amino group, then introducing the polar group through polymer reaction.

As techniques for introducing the polar group into the side chain, there are, for example, a technique of polymerizing a polar group-containing monomer (e.g., (meth)acrylic acid, maleic acid, partially esterified maleic acid, itaconic acid, crotonic acid, 2-carboxyethyl(meth)acrylate, 2-sulfoethyl (meth)acrylate, 2-phosphonoxyethyl(meth)acrylate, 2,3-dihydroxypropyl(meth)acrylate, 2-N,N-dimethylaminoethyl(meth)acrylate, (meth)acryloyloxyethyltrimethylammonium•PF6 ion salt, or an adduct between a hydroxyl group-containing unsaturated compound and a cyclic acid anhydride (e.g., maleic acid anhydride, glutaric acid anhydride or phthalic acid anhydride), and a technique of utilizing polymer reaction (for example, a reaction between a hydroxyl group, an amino group or an epoxy group and an acid anhydride or a halogen-substituted acid compound, and a reaction between an isocyanato group or a carboxyl group and an acid compound having a hydroxyl group or an amino group)

As specific examples of the polar group-containing polymer component, reference may be made to the descriptions given in JP-A-11-153703, paragraphs [0024] to [0041].

Also, in the polymer dispersing agent having the polar group in the side chain, the content of the polymerization unit containing the polar group is in a range of preferably from 0.5 to 50% by weight, more preferably from 1 to 40% by weight, particularly preferably from 5 to 30% by weight, based on the weight of the total polymerization units.

Also, when the cross-linkable or polymerizable group is bound to the side chain, the total number of atoms (excluding hydrogen atoms bound to carbon atom, nitrogen atom, silicon atom and the like) between the polymer main chain and the cross-linkable or polymerizable group is preferably 6 or more, still more preferably 8 to 22, whereby the cross-linking or polymerization reaction proceeds more smoothly.

The dispersing agent in accordance with the invention preferably has a polymerization unit having an ethylenically unsaturated group in the side chain as the cross-linkable or polymerizable functional group. As examples of the polymerization unit having an ethylenically unsaturated group in the side chain, there can be utilized polymerization unit of poly-1,2-butadiene or poly-1,2-isoprene structure, or a polymerization unit of (meth)acrylic acid ester or amide to which a specific residue (R in —COOR or —CONHR) is bound.

Examples of the specific residue (R) include —(CH₂)ₙ—CR₁═CR₂R₃, —(CH₂O)n-CH₂CR₁═CR₂R₃, —(CH₂CH₂O)n-CH₂CR₁═CR₂R₃. —(CH₂)n-NH—CO—O—CH₂CR₁═CR₂R₃, —(CH₂)n-O—CO—R₁═CR₂R₃ and —(CH₂CH₂O)₂—X (wherein R₁ to R₃ each represents a hydrogen atom, a halogen atom (e.g., a fluorine atom or a chlorine atom), an alkyl group containing 1 to 20 carbon atoms, an aryl garoup, an alkoxy group, an aryloxy group or a cyano group, R₁ and R₂ or R₃ are optionally bound to each other to form a ring, n represents an integer of 1 to 10, and X represents a dicyclopentadienyl residue). Examples of the specific residue in the ester moiety include —CH₂CH═CH₂ (corresponding to the polymer of allyl(meth)acrylate described in JP-A-64-17047), —CH₂CH₂O—CH₂CH═CH₂, —CH₂CH₂OCOCH═CH₂, —CH₂CH₂OCOC(CH₃)═CH₂, —CH₂C(CH₃)═CH₂, —CH₂CH═CH—C₆H₅, —CH₂CH₂OCOCH═CH—C₆H₅, —CH₂CH₂—NHCOO—CH₂CH═CH₂ and —CH₂CH₂O—X (wherein X represents a dicyclopentadienyl residue). Examples of the specific residues in the amido moiety include —CH₂CH═CH₂, —CH₂CH₂—Y (wherein Y represents a 1-cyclohexenyl residue), —CH₂CH₂—OCO—CH═CH₂, and —CH₂CH₂—OCO—C(CH₃)═CH₂.

With the dispersing agent having ethylenically unsaturated group, curing occurs when a free radical (a polymerization-initiating radical or a growing radical produced in the course of polymerization of a polymerizable compound) adds to the unsaturated bond group to cause addition polymerization between molecules directly or via a polymer chain of the polymerizable compound. Or, curing occurs when an atom in the molecule (e.g., a hydrogen atom on the carbon atom adjacent to the unsaturated bond) is withdrawn by a free radical to produce polymer radicals, and the polymer radicals are then bound to each other to form a cross-linkage between the molecules.

As techniques for introducing the cross-linkable or polymerizable functional group into the side chain, reference may be made to the descriptions given in, for example, JP-A-3-249653.

Also, as to the content of the cross-linkable or polymerizable functional group, the group may constitute all polymerization units other than the polar group-containing polymerization units, and the content of the cross-linkable or plymerizable group-containing unit is preferably 1 to 70% by weight, particularly preferably 5 to 50% by weight, based on the whole polymerization units of the dispersing agent.

The dispersing agent in accordance with the invention may be a copolymer of a polar group-containing polymeriable component, a cross-linkable or polymerizable functional group-containing polymerizable component and other polymerizable component. The other polymerizable component is not particularly limited so long as it is copolymerizable with monomers corresponding to the polar group-containing polymerizable component and the cross-linkable or polymerizable functional group-containing copolymerizable component, and is selected in various points of view such as dispersion stability and strength of formed film. Preferred examples thereof include methacrylates, acrylates, vinyl carboxylates, (meth)acrylamide and the derivatives thereof, styrene and its derivatives, and acrylonitrile. The content of the other polymerizable component in the polymer dispersing agent is preferably 5 to 95% by weight, more preferably 30 to 85% by weight, based on the whole polymerizable components. Specific examples of the dispersing agent containing the other polymerizable component are given in, for example, JP-A-11-153703, paragraphs [0023] to [0042].

The dispersing agent in accordance with the invention is not particularly limited as to polymerization form, but block copolymers or random copolymers are preferred. Further, AB type block copolymers which are constituted by a polymer block A containing a cross-linkakble or polymerizable group-containing polymerizable component (block A) and a polymer block B containing a polar group-containing polymerizable component (block B), ABA type block copolymers and graft-type block copolymers are preferred. The block copolymer structure of the dispersing agent enables one to convert the composite oxide fine particles into fine particles and improve stability of the resulting dispersion and film thickness of the cured film. This may be attributed to that the polymer chain adsorbs onto the composite oxide fine particles in a dispersing solvent in a tail-like form, which facilitates adsorption of the high polymer onto the fine particles and makes easier the progress of curing reaction of the polymer block (block A).

The block copolymers can be produced according to the conventionally known living polymerization reaction process. That is, the AB type and ABA type block copolymers can be synthesized by known so-called living polymerization reaction such as ion polymerization reaction (using an organometallic compound (e.g., an alkyllithium, lithium diisopropylamide or an alkylmagnesium halide) or hydrogen iodide/iodine system), photopolymerization reaction using a porphyrin metal complex as a catalyst, group-migrating polymerization reaction or polymerization reaction under irradiation with light using a dithiocarbamate group-containing compound and/or a xanthate group-containing compound as an initiator.

The living polymerization can be conducted according to the synthesis processes described in, for example, P. Lutz, P. Masson, et al, Polym. Bull. 12, 79 (1984), B. C. Anderson, G. D. Andrews, et al, Macromolecules, 14, 1601 (1981), Koichi Migite and Koichi Hatada, Kobunshi Kako, 36, 366 (1987), Toshinobu Higashimura and Mitsuo Sawamoto, Kobunshi Ronbunshu, 46, 189 (1989), M. Kuroki and T. Aida, J. Am. Chem. Soc., 109, 4737 (1987), D. Y. Sogah, W. R. Hertler, et al, Macromolecules, 20, 1473 (1987), Takayuki Otsu, Kobunshi, 37, k 248 (1988), and Shun-ichi Himori and Ryuichi Otsu, Polym. Rep. Jap., 37, 3508 (1988).

The AB type block copolymers can also be synthesized by the process of synthesizing a graft type copolymer through radical polymerization reaction using a synthesis-monofunctional macromonomer (process for synthesizing the monofunctional macromonomer being that described in the literatures of Yoshiki Nakajo and Yuya Yamashita, Senryo To Yakuhin, 30, 232 (1985), Akira Ueda and Susumu Nagai, Kagaku To Kogyo, 60, 57 (1986), P. F. Pempp & E. Franta, Advances in Polymer Science, 58, 1 (1984), etc.) or by the process of radical polymerization reaction using an azobis high polymer initiator (Akira Ueda and Susumu Nagai, Kagaku To Kogyo, 60, 57 (1986), etc.).

The amount of the dispersing agent for the composite oxide fine particles is in a range of preferably from 1 to 100% by weight, more preferably from 5 to 50% by weight, most preferably from 10 to 40% by weight. Two or more of the dispersing agents may be used in combination.

(Dispersing Medium)

As a dispersing medium for wet-dispersing the composite oxide fine particles of the invention, a liquid having a boiling point of 50° C. or more is preferably used. Organic solvents having a boiling point of 60° C. to 180° C. are more preferred.

Examples of the dispersing medium to be used in the invention include alcohols (e.g., methanol, ethanol, propanol, butanol, benzyl alcohol, ethylene glycol, propylene glycol, and ethylene glycol monoacetate), ketones (e.g., methyl ethyl ketone, methyl isobutylo ketone, cyclohexanone, and methylcyclohexanone), estgers (e.g., methyl acetate, ethyl acetate, propyl acetate, butyl acetate, ethyl formate, propyl formate, butyl formate, and ethyl lactate), aliphatic hydrocarbons (e.g., hexane and cyclohexane), halogenated hydrocarbons (e.g., methylchloroform), aromatic hydrocarbons (e.g., benzene, toluene, and xylene), amides (e.g., dimethylformamide, dimethylacetamide, and n-methylpyrrolidone), ethers (e.g., dioxane, tetrahydjrofuran, ethylene glycol dimethyl ether, and propylene glycol dimethyl ether), and ether alcohols (e.g., 1-methoxy-2-propanol, ethyl cellosolve, and methylcarbinol). These may be used alone or in combination of two or more of them. Preferred dispersing media include toluene, xylene, methyl ethyl ketone, methyl isobutyl ketone, cyclohexanone, and butanol.

The dispersing medium is used in an amount so that the content of the whole dispersing composition components including the composite oxide fine particles and the dispersing agent becomes preferably 5 to 50% by weight, more preferably 10 to 30% by weight. In this range, dispersion proceeds easily, and there results a dispersion having a viscosity giving good workability.

(Making Fine the High Refractive Index Composite Oxide Particles)

The high refractive index composite oxide fine particles in accordance with the invention are uniformly dispersed in an fine state of 150 nm or less in average particle size in a curable coating composition. Thus, a cured film formed from the curable coating composition can be a transparent, highly refractive cured film having uniform optical properties.

Dispersing of the high refractive index composite oxide particles as the fine particles of the above-described average particle size can be attained only by the wet-dispersing method using media of not more than 1 mm in average particle size together with the dispersing agent.

As a wet-dispersing machine, there may be illustrated conventionally known ones such as a sand grinder mill (e.g., a pinned beads mill), a dynomil, a high-speed impeller mill, a pebble mill, a roller mill, an attritor mill, and a colloid mill. In particular, a sand grainder mill, a dynomil and a high-speed impeller mill are preferred for dispersing the composite oxide fine particles of the invention as fine particles.

As the media to be used in the dispersing machine, those which have an average particle size of less than 1 mm are used to obtain the fine inorganic particles of 100 nm or less in average particle size having a uniform particle size. The average particle size of the media is preferably 0.8 mm or less, more preferably 0.1 to 0.5 mm.

Also, as the media to be used for the wet-dispersing, beads are preferred. Specific examples thereof include zirconia beads, glass beads, ceramic beads and steel beads. Zirconia beads of 0.1 to 0.5 mm in average size are particularly preferred due to the durability and small particle size thereof.

The dispersing temperature in the dispersing step is preferably 20 to 60° C., more preferably 25 to 45° C. Dispersing into the fine particles at a temperature within this range does not cause reagglomeration and precipitation of the dispersed particles. This may be attributed to that adsorption of the dispersing agent onto the composite oxide particles is conducted so appropriately that dispersion stability failure due to desorption of the dispersing agent from the particles does not take place.

Also, a preliminary dispersing treatment may be conducted prior to the wet-dispersing step. Examples of a dispersing machine to be used for the preliminary dispersing treatment include a ball mill, a three-roll mill, a kneader and an extruder.

The composite oxide fine particles produced by the wet-dispersing method of the invention are preferably made as fine as possible in the dispersing medium, and the weight-average particle size thereof in the curable coating composition is 150 nm or less. Only in this range, the composition can form a high refractive index film not sacrificing transparency and having excellently uniform refractive index. The average particle size of the composite oxide fine particles is preferably 5 to 150 nm, more preferably 10 to 100 nm, still more preferably 10 to 80 nm.

Also, it is preferred that the fine particles do not contain large particles of 500 nm or more in average particle size. The content of such large particles is preferably 10% or less based on the whole particles. Further, the content of particles of 300 nm or more in average particle size is 10% or less.

The shape of the composite oxide fine particles is not particularly limited, and there may be illustrated a rice grain-like shape, a spherical shape, a cubic shape, a spindle-like shape, a short fiber-shape and an indefinite shape.

Also, the high refractive index composite oxide fine particles of the invention may preferably be a core/shell structure fine particles wherein the core is the fine particle and the shell comprises an inorganic compound. As such shell, an oxide of at least one element selected from among Al, Si and Zr is preferred. Specifically, there are illustrated those described in, for example, JP-A-2001-166104.

[Cured Film]

The cured film of the invention is formed as a uniform thin film by coating the curable coating composition containing at least the high refractive index composite oxide fine particles and the film-forming curable compound, then curing by light and/or heat.

The cured film formed from the curable coating composition of the invention preferably has a high refractive index of 1.85 to 2.50, more preferably 1.90 to 2.30.

Also, the size of the fine particles existing in the matrix of the cured film is 100 nm or less in average particle size, preferably 5 to 100 nm, more preferably 10 to 100 nm, most preferably 10 to 80 nm.

The matrix for the high refractive index layer and the curable compound for forming film are described below in detail.

The high refractive index layer contains at least the fine particles of the high refractive oxide and a matrix.

According to a preferred embodiment of the invention, the matrix for the high refractive index layer is formed by coating a composition for forming the high refractive index layer which composition contains at least either of (1) an curable organic binder and (2) an organometallic compound having a hydrolysable functional group and/or its partial condensate, and curing it.

The film-forming curable compound is at least either of (1) a curable organic binder and (2) an organometallic compound having a hydrolysable functional group and/or its partial condensate. It is also preferred to use both of (1) and (2) in combination.

(1) Curable Organic Binder

As the curable organic binder, there are illustrated binders formed from:

(i) conventionally known thermoplastic resins;

(ii) a combination of a conventionally known reactive curable resin and a curing agent; and

(iii) a combination of a binder precursor (a curable poly-functional monomer or a poly-functional oligomer to be described hereinafter) and a polymerization initiator.

A coating composition for forming the high refractive index layer or the curable coating composition (hereinafter, the term “coating composition” ocasionally means both of A coating composition for forming the high refractive index layer or the curable coating composition) is prepared from a dispersion containing a binder-forming component of (i), (ii) or (iii) described above, the high refractive index composite oxide fine particles and the dispersing agent. The coating composition is coated on a transparent support to form a coated film, then cured by a method appropriate for the particular binder-forming component used to thereby form a high refractive index layer. The curing method is properly selected depending upon the kind of binder component. For example, there is illustrated a method of causing cross-linking reaction or polymerization reaction of a curing compound (e.g., a poly-functional monomer or a poly-functional oligomer) by means of at least either of heating or irradiation with light. Especially, a method of forming a cured binder by causing cross-linking reaction or polymerization reaction of the curable compound through irradiation with light using the combination of (iii) described above is preferred.

Further, it is preferred to cause cross-linking reaction or polymerization reaction of the dispersing agent contained in the dispersion of the fine particles of the high refractive index composite oxide simultaneously with or after coating of the coating composition.

In the thus-prepared high refractive index layer or the cured film, the dispersing agent and the precursor of the binder, the curable poly-functional monomer or the poly-functional oligomer, have undergone the cross-linking or polymerization reaction, thus the anionic group of the dispersing agent being taken in the binder. Further, the binder in the high refractive index layer or the cured film functions so that the anionic group can maintain the dispersed state of the inorganic fine particles, and hence the cross-linkage or polymerization structure imparts a film-forming ability to the binder to improve physical strength, chemical resistance and weatherability of the high refractive index layer or the cured film containing the high refractive index composite oxide fine particles.

Examples of the thermoplastic resin include a polystyrene resin, a polyester resin, a cellulose resin, a polyether resin, a vinyl chloride resin, a vinyl acetate resin, a vinyl chloride/vinyl acetate copolymer resin, a polyacrylic resin, a polymethacrylic resin, a polyolefin resin, a urethane resin, a silicone resin and an imide resin.

Also, as the reactive curable resin, a thermo-setting and/or ionizing radiation-curable resin is preferably used. Examples of the thermo-setting resin include a phenol resin, a urea resin, a diallyl phthalate resin, a melamine resin, a guanamine resin, an unsaturated polyester resin, a polyurethane resin, an epoxy resin, an amino alkyd resin, a melamine-urea co-condensation resin, a silicone resin and a polysiloxane resin. Examples of the ionizing radiation-curable resin include resins having a functional group such as a radical-polymerizable unsaturated group (e.g., an acryloyloxy group, a styryl group, or a vinyloxy group) and/or a cation-polymerizable group (e.g., an epoxy resin or a thioepoxy resin), and the resins are exemplified by a polyester resin, a polyether resin, an acrylic resin, a n epoxy resin, a urethane resin, an alkyd resin, a spiroacetal resin, a polybutadiene resin, and a polythiolpolyene resin.

These reactive curable resins are used by adding, as needed, conventionally known compounds such as a cross-linking agent (e.g., an epoxy compound, a polyisocyanate compound, a polyol compound, a polyamine compound or a melamine compound), a polymerization initiator (e.g., a UV photo initiator such as an azobis comound, an organic peroxy compound, an organic halogen compound, an onium salt compound or a ketone comound), and a polymerization accelerator (e.g., an organometaqllic compound, an acid compound or a basic compound). Specifically, there are illustrated, for example, those compounds which are described in Kakyo Handbook written by Shinzo Yamasita and Tosuke Kaneko (published by Taiseisha in 1981).

Now, descriptions are given mainly by referring to a preferred method of forming a cured binder, i.e., a method of forming a binder by causing cross-linking or polymerization reaction of a curable compound through irradiation with light, using the combination (3) described hereinbefore.

As functional groups for the photo-curable, poly-functional monomer or the poly-functional oligomer, there are illustrated functional groups which can be polymerized by irradiation with UV rays, electron beams or radiation. Of these, UV ray-polymerizable functional groups are particularly preferred. The functional groups of the photo-curable poly-functional monomer or poly-functional oligomer may be either radical-polymerizable or cation-polymerizable.

AS the radical-polymerizable group, there are illustrated ethylenically unsaturated groups such as a (meth)acryloyl group, a vinyloxy group, a styryl group and an allyl group, with (meth)acryloyl group being preferred.

It is preferred to incorporate a poly-functional monomer having 2 or more radical-polymerizable groups within the molecule.

The radical-polymerizable, poly-functional monomer is preferably selected from compounds having at least 2 terminal, ethylenically unsaturated bonds. More preferred are compounds having 2 to 6 terminal, ethylenically unsaturated bonds within the molecule. Such compounds are widely known in the field of polymer materials, and they may be used without any particular limitation. These may be in a chemical form of, for example, monomer, prepolymer, i.e., dimer, trimer or oligomer, or a mixture thereof or a copolymer thereof. Examples of the radical-polymerizable monomer include an unsaturated carboxylic acid (e.g., acrylic acid, methacrylic acid, itaconic acid, crotonic acid, isocrotonic acid or maleic acid), an ester or amide thereof and, preferably, esters between an unsaturated carboxylic acid and an aliphatic polyhydric alcohol compound and amides between an unsaturated carboxylic acid and an aliphatic polyamine compound are illustrated. Also, adducts between an unsaturated carboxylic acid ester or amide having a nucleophilic substituent such as a hydroxyl group, an amino group or a mercapto group and a mono-functional or poly-functional isocyanate or epoxy compound, and dehydration condensation products with poly-functional carboxylic acids may be used. Also, reaction products between unsaturated carboxylic acid esters or amides having an electrophilic substituent such as an isocyanato group or an epoxy group and mono-functional or poly-functional alcohols, amines or thiols are preferred. As other examples, compounds prepared by using unsaturated phosphonic acid or styrene in place of the unsaturated carboxylic acid may be used as well.

Examples of the aliphatic polyhydric alcohol compound include ethylene glycol, propylene glycol, butanediol, hexanediol, diethylene glycol, neopentyl glycol, trimethylolpropane, trimethylolethane, cyclohexanediol, cyclohexanetriol, inositol, cyclohexanedimethanol, pentaerythritol, sorbitol, dipentaerythritol, tripentaerythritol, glycerin and diglycerin. As examples of the polymerizable compounds between the aliphatic polyhydric alcohol and the unsaturated carboxylic acid, there are illustrated compounds described in JP-A-2001-139663, paragraphs [0026] to [0027].

As other examples of the polymerizable esters, there may preferably be used, for example, vinyl methacrylate, allyl methacrylate, allyl acrylate, aliphatic alcohol series esters described in JP-B-46-27926, JP-B-51-47334 and JP-A-57-196231, those which have an aromatic skeleton and described in JP-A-2-226149, and amino group-having compounds described in JP-A-1-165613 may preferably be used as well.

Also, specific examples of the polymerizsable amide monomers between the aliphatic polyhydric amine compound and the unsaturated carboxylic acid include methylenebis-(meth)acrylamide, 1,6-hexamethylenebis-(meth)acrylamide, diethylenetriamine tris(meth)acrylamide, xylylenebis(meth)acrylamide, and compounds having a cyclohexylene structure and described in JP-B-54-21726.

Also, vinylurethane compounds having 2 or more polymerizable vinyl groups within the molecule (e.g., JP-B-48-41708), urethane acrylates (e.g., JP-B-2-16765), urethane compounds having an ethylene oxide skeletone (e.g., JP-B-62-39418), polyesteracrylates (e.g., JP-B-52-30490), and photo-curable monomers and oligomers described in Nihon Secchaku Kyokaishi, vol. 20, No. 7, pp. 300 to 308 (1984) may also be usable.

These radical-polymerizable polyfunctional monomers may be used in combination of two or more of them.

Next, the cation-polymerizable group-containing compounds (hereinafter also referred to as “cation-polymerizable compounds” or “cation-polymerizable organic compounds”) are described below.

As the cation-polymerizable compound to be used din the invention, any of thosemaybe used which undergo polymerization reaction and/or cross-linking reaction when irradiated with an active energy rays in the presence of an active energy rays-sensitive, cation polymerization initiator. Typical examples thereof include epoxy compounds, cyclic thioether compounds, cyclic ether compounds, spiroorthoester compounds, and vinyl ether compounds. In the invention, one or more of the cation-polymerizable compounds may be used.

As the cation-polymerizable group-containing compound, compounds having 2 to 10 cation-polymerizable groups within the molecule are preferred, with compounds having 3 to 5 cation-polymerizable groups being particularly preferred. The molecular weight of the curing agent is 3000 or less, preferably in a range of from 200 to 2000, particularly preferably in a range of from 400 to 1500. If the molecular weight is too small, evaporation becomes problematical in the course of the film-forming step whereas, if too large, compatibility with a cellulose acylate dope composition becomes poor, thus such molecular weight not being preferred.

As the epoxy compound, there are illustrated aliphatic epoxy compounds and aromatic epoxy compounds.

As the aliphatic epoxy resin, there are illustrated, for example, a polyglycidyl ether of the aliphatic polyhydric alcohol or its alkylene oxide adduct, a polyglycidyl ester of an aliphatic long-chained polybasic acid, a homopolymer or copolymer of glycidyl acrylate or glycidyl methacrylate. Further, in addition to the above-described epoxy compounds, there may be illustrated, for example, a monoglycidyl ether of an aliphatic higher alcohol, a glycidyl ester of a higher aliphatic acid, epoxidated soybean oil, butyl epoxystearate, octyl epoxystearate, epoxydated linseed oil, and epoxidated polybutadiene.

Also, as the alicyclic epoxy compound, there may be illustrated a polyglycidyl ether of a polyhydric alcohol having at least one alicyclic ring and a cyclohexene oxide- or cyclopentene oxide-containing compound obtained by epoxydation of an unsaturated alicyclic ring (e.g., cyclohexene, cyclopentene, dicyclooctene or tricyclodecene)-containing compound with a proper oxidizing agent such as hydrogen peroxide or an peracid.

Also, as the aromatic epoxy compound, there are illustrated, for example, mono- or polyglycidyl ethers of a monohydric or polyhydric phenol having at least one aromatic nucleus or the alkylene oxide adduct thereof. As these epoxy compounds, there are illustrated, for example, the compounds described in JP-A-11-242101, paragraphs [0084] to [0086] and the compounds described in JP-A-10-158385, paragraphs [0044] to [0046].

Of these epoxy compounds, the aromatic epoxides and alicyclic epoxides are preferred in view of rapidly curing properties, with the alicyclic epoxides being particularly preferred. In the invention, the epoxides may be used independently or in a proper combination of two or more of them.

As the cyclic thioether compounds, there are illustrated those compounds wherein the epoxy ring of the above-described compounds is replaced by a thioepoxy ring.

The compounds containing oxetanyl group as a cyclic ether have 1 to 10, preferably 1 to 4, oxetanyl groups. These compounds are preferably used in combination with the epoxy group-containing compound.

Specifically, there are illustrated, for example, compounds described in JP-A-2000-239309, paragraphs [0024] to [0025].

As the spiroorthoester compounds, there are illustrated, for example, compounds described in JP-T-2000-506908.

As the vinylhydrocarbon compounds, there are illustrated styrene compounds, vinyl-substituted alicyclic hydrocarbon compounds (e.g., vinylcyclohexane and vinylbicycloheptene), compounds having been described with respect to the radical-polymerizable monomers (wherein V1 corresponds to —O—), propenyl compounds (described in, for example, Journal of Polymer Science: Part A: Polymer Chemistry, Vol. 32, 2895 (1994)), alkoxyallene compounds (described in, for example, Journal of Polymer Science: Part A: Polymer Chemistry, Vol. 34, 1015 (1996) and JP-A-2002-29162), and isopropenyl compounds (described in, for example, Journal of Polymer Science: Part A: Polymer Chemistry, Vol. 34, 2051 (1996).

These compounds may be used in a proper combination of two or more of them.

Also, as the poly-functional compounds of the invention, compounds having at least one of the above-described radical-polymerizable groups and the cation-polymerizable groups within the molecule are preferred to use. For example, there are illustrated compounds described in JP-A-8-277320, paragraphs [0031] to [0052] and JP-A-2000-191737, paragraph [0015]. Compounds to be used in the invention are not limited only to them.

The radical-polymerizable compound and the cation-polymerizable compound are contained in a proportion by weight of preferably 90:10 to 20:80, j more preferably 80:20 to 30:70, in terms of radical-polymerizable compound cation-polymerizable compound.

Next, a polymerization initiator to be used in combination with the binder precursor in the aforesaid combination (3) is described in detail below.

As the polymerization initiator, there are illustrated a thermal polymerization initiator and a photo polymerization initiator.

Examples of the thermal polymerization initiator include conventionally known organic peroxy compounds (e.g., compounds described in JP-A-2001-139663, paragraph [0019]), azobis compounds, and oinum compounds to be described hereinafter.

As the photo polymerization initiator, compounds capable of generating a radical or an acid upon being irradiated with light are illustrated. The photo polymerization initiator to be used in the invention has a maximum absorption wavelength of preferably 400 nm or less. Compounds having an absorption wavelength in such UV ray region permits to handle under a white lamp.

The radical-generating, polymerization initiator to be preferably used in the invention is a photo polymerization initiator which generates a radical upon being irradiated with light to initiate and accelerate polymerization of a compound having a polymerizable unsaturated group.

As the radical-generating compound, a proper one may be selected to use from known polymerization intiators and compounds having a bond with a small bond dissociation energy. The radical-generating, polymerization initiators may be used alone or in combination of two or more of them.

As the radical-generating, polymerization initiator, there are illustrated amine compounds (described in JP-B-44-20189), organic halogenated compounds, carbonyl compounds, metallocene compounds, hexaarylbiimidazole compounds, organoic boric acid compounds and disulfone compounds (described in JP-A-61-166544). Of these, carbonyl compounds are preferred.

As the organic halogenated compound, specific examples are described in Wakabayashi, et al, Bull Chem. Soc. Japan, 42, 2924 (1969), U.S. Pat. No. 3,905,815, M. P. Hutt, Journal of Heterocyclic Chemistry, 1 (No. 3), (1979), and particular examples thereof include trihalomethyl group-substituted oxazole compounds and s-triazine compounds. More preferably, there are illustrated s-triazine derivatives wherein at least one mono-, di- or tri-halogen-substituted methyl group is bound to the s-triazine ring.

As other organic halogen compounds, there are illustrated ketones, sulfides, sulfones and nitrogen atom-containing hetero ring groups described in JP-A-5-27830, paragraphs [0039] to [0048].

As the carbonyl compound, there are illustrated, for example, compounds described in Saishin UV Koka Gijutsu, pp. 60 to 62 (published by Kabushiki Kaisha Gijutsu Joho Kyokai in 1991), acetophenone compounds, hydroxyacetophenone compounds, benzophenone compounds, thioxane compounds, benzoin compounds such as benzoin ethyl ether and benzoin isobutyl ether, benzoate derivatives such as ethyl p-dimethylaminobenzoate and ethyl p-diethylaminobenzoate, benzyl dimethyl ketal and acylphosphine oxide.

As the metallocene compound, there are illustrated titanocene compounds (e.g., JP-A-5-83588) and iron-arene complexes (e.g., JP-A-1-152109). As the hexaarylbiimidazole compound, there are illustrated compounds described in JP-B-6-29285 and U.S. Pat. No. 4,622,286. As the organic borate compound, there are illustrated, for example, compounds described in Japanese Patent No. 2764769, JP-A-2002-116539, Kunts, Martin, Rad Tech'98. Proceeding Apr. 19-22, 1988, Chicago and, as other organoboron compounds, there are illustrated organoboron transition metal coordinate complexes (e.g., JP-A-7-292014).

These radical-generating compounds may be added alone or in combination of two or more of them. They can be added in an amount of 0.1 to 30% by weight, preferably 0.5 to 25% by weight, particularly preferably 1 to 20% by weight, based on the whole amount of the photo radical-polymerizable monomers. When they are added in an amount within this range, the resulting coating composition acquires a satisfactory stability with time and shows a high polymerizing property.

Next, an acid generating agent which can be used as the photo polymerization initiator is described in detail below.

As the acid generating agent, there are illustrated known compounds such as photo initiators for photo-cationic polymerization, light-quenching agents (e.g., dyes), light color-changing agents, and known acid-generating agents used for microresists, and mixtures thereof.

Examples of the acid-generating agent include organic halogenized compounds, disulfone compounds and onium compounds. As specific examples of the organohalogenized compounds and the disulfone compounds, there may be illustrated the same compounds as those described with respect to the radical-generating compounds.

Examples of the onium compound include diazonium salts, ammonium salts, iminium salts, phosphonium salts, iodonium salts, sulfonium salts, arsonium salts and selenonium salts, and there are illustrated, for example, those compounds which are described in JP-A-2002-29162, paragraphs [0058] to [0059]. The onium salts are particularly preferably used as the acid-generating agent and, especially, diazonium salts, iodonium salts, sulfonium salts and iminium salts are preferred in view of photosensitivitiy upon initiation of photo polymerization and material stability of the compounds.

Specific examples of the onium salt include amylated sulfonium salts described in JP-A-9-268205, paragraph [0035], diaryliodonium salts or triarylsulfonium salts described in JP-A-2000-71366, paragraphs [0010] to [0011], sulfonium salts of S-phenyul thiobenzoate described in JP-A-2001-288205, paragraph [0017], and onium salts described in JP-A-2001-133696, paragraphs [0030] to [0033].

As other examples of the acid-generating agent, there are illustrated organic metal/organic halide compounds described in JP-A-2002-29162, paragraphs [0059] to [0062], photo acid-generating agents having an o-nitrobenzyl type protective group, and compounds capable of generating sulfonic acid upon photolysis.

These acid-generating agents may be used alone or in combination of two or more of them. These acid-generating agents may be added in an amount of 0.1 to 50% by weight, preferably 0.5 to 20% by weight, particularly preferably 1 to 15% by weight, based on 100 parts by weight of the whole polymerizing compounds. Addition of the acid-generating agent in the above-described range is preferred in view of stability of the resulting coating composition and polymerization reactivity.

In using the radical-polymerizable organic compound and the cation-polymerizable organic compound in combination in the coating composition, it is preferred to incorporate 0.5 to 10% by weight of the radical polymerization initiator and 1 to 10% by weight of the cation polymerization initiator based on the total weight of the composition. More preferably, the radical polymerization initiator is incorporated in an amount of 1 to 5% by weight, and the cation polymerization intiator in an amount of 2 to 6% by weight.

A photo sensitizing agent may be used in addition to the photo polymerization initiator. Specific examples of the photo sensitizing agent include organic amine compounds (n-butylamine, triethylamine and N-phenylglycine), phosphines (e.g., tri-n-butylphosphine), Michler's ketone and thioxanthone. As commercially available photo sensitizing agents, there are illustrated KAYACURE (DMBI, EPA) made by Nihon Kayaku K.K., etc.

The photo polymerization reaction is preferably conducted by irradiation with UV rays after coating and drying the coating composition.

(2) Organometallic Compound Having a Hydrolysable Functional Group

It is also preferred to form, as a matrix for the high refractive index layer or in the cured film of the invention, a coating film by sol-gel reaction using the organometallic compound having a hydrolysable functional group and/or its hydrolyzate, followed by curing the film. As the organometallic compound, there are illustrated compounds cmprising Si, Ti, Zr, Al or the like. As the hydrolizable functional group, there are illustrated an alkoxy group, an alkoxycarbonyl group, a halogen atom and a hydroxyl group, with an alkoxy group such as a methoxy group, an ethoxy group, a propoxy group or a butoxy group being particularly preferred.

Preferred examples of the organometallic compound is preferably an organosilicone compound represented by the following general formula and its partial hydrolyzate (partial condensate). Additionally, it is a well known fact that the organosilicon compounds represented by the general formula (1) can be readily hydrolyzed and subsequently undergo dehydrating condensation reaction.
(R^{a})m-Si(X)n General formula (1)

In the general formula (1), R^{a} represents a substituted or unsubstituted aliphatic group containing 1 to 30 carbon atoms or substituted or an unsubstituted aryl group containing 6 to 14 carbon atoms, X represents a halogen atom (e.g., a chlorine atom or a bromine atom), OH group, OR^{b} group or OCOR^{b} group (wherein R^{b} represents a substituted or unsubstituted alkyl group), m represents an integer of 0 to 3, and n represents an integer of 1 to 4, with the sum of m and n being 4, provided that, when m represents 0, X represents OR^{b} or OCOR^{b}.

In the general formula (1), preferred examples of the aliphatic group represented by R^{a} include those which contain 1 to 18 carbon atoms, (e.g., methyl, ethyl, propyl, butyl, pentyl, hexyl, oxtyl, decyl, dodecyl, hexadecyl, octadecyl, benzyl, phenethyl, cyclohexyl, cyclohexylmethyl, hexenyl, decenyl, and dodecenyl). More preferred are those which contain 1 to 12, particularly preferably 1 to 8, carbon atoms. Examples of the aryl group represented by R^{a} include phenyl, naphthyl and anthranyl, with phenyl being preferred.

Substituents are not particularly limited, but preferred examples thereof include a halogen atom (e.g., fluorine, chlorine or bromine), a hydroxyl group, a mercapto group, a carboxyl group, an epoxy group, an alkyl group (e.g., methyl, ethyl, i-propyl, propyl ort-butyl), an aryl group (e.g., phenyl or naphthyl), an aromatic hetero ring group (furyl, pyrazolyl or pyridyl), an alkoxy group (e.g., methoxy, ethoxy, i-propoxy or hexyloxy), an aryloxy group (e.g., phenoxy), an alkylthio group (e.g., methylthio or ethylthio), an arylthio group (e.g., phenylthio), an alkenyl group (e.g., vinyl or 1-propenyl), an alkoxysilyl group (e.g., trimethoxysilyl or triethoxysilyl), an acyloxy group (acetoxy or (meth)acryloyl), analkoxycarbonyl group (e.g., methoxycarbonyl or ethoxycarbonyl), an aryloxycarbonyl group (e.g., phenoxycarbonyl), a carbamoyl group (e.g., carbamoyl, N-methylcarbamoyl, N,N-dimethylcarbamoyl or N-methyl-N-octylcarbamoyl), and an acylamino group (acetylamino, benzoylamino, acrylamino or methacrylamino).

Of these, more preferred are a hydroxyl group, a mercapto group, a carboxyl group, an epoxy group, an alkyl group, an alkoxysilyl group, an acyloxy group and an acylamino group, with an epoxy group, a polymerizable acyloxy group ((meth)acryloyl), and a polymerizable acylamino group (acrylamino or methacrylamino). These substituents may further be substituted.

R^{b} represents a substituted or unsubstituted alkyl group. As the substituent for the alkyl group, there may be used the same ones as have been illustrated with respect to R^{a}.

m represents an integer of 0 to 3. n represents an integer of 1 to 4. The sum of m and n is 4. m preferably represents 0, 1 or 2, particularly preferably 1. When m represents 0, X represents OR^{b} group or OCOR^{b} group.

The content of the compound of the general formula (1) is preferably 10 to 90% by weight, more preferably 20 to 70% by weight, particularly preferably 30 to 50% by weight, based on the total solid components of the high refractive index layer or cured film.

Specific examples of the compound of the general formula (1) are compounds described in JP-A-2001-166104, paragraphs [0054] to [0056].

In the high refractive index layer or cured film, the organic binder preferably has a silanol group. Existence of the silanol group in the binder serves to more improve physical strength, chemical resistance and weatherability of the high refractive index layer or cured film.

The silanol group can be introduced into the binder by, for example, compounding the cross-linkable or polymerizable functional group-containing organosilicon compound represented by the general formula (1) as a binder-forming component constituting the coating composition together with the binder precursor (e.g., curable poly-functional monomer or poly-functional oligomer), a polymerization initiator, and a dispersing agent contained in the dispersion of the high refractive index composite oxide fine particles, and coating this coating composition on a transparent support, then causing cross-linking reaction or polymerization reaction among the dispersing agent, poly-functional monomer or polyfunctional oligomer, and the compound represented by the general formula (1).

In the case of incorporating the silanol group-containing repeating unit, its content is preferably 2 to 98 mol %, more preferably 4 to 96 mol %, most preferably 6 to 94 mol %.

Hydrolysis/condensation reaction for curing the organometallic compound in accordance with the invention is preferably conducted in the presence of a catalyst. Examples of the catalyst include inorganic acids such as hydrochloric acid, sulfuric acid and nitric acid, organic acids such as oxalic acid, acetic acid, formic acid, trifluoroacetic acid, methanesulfonic acid and toluenesulfonic acid, inorganic bases such as sodium hydroxide, potassium hydroxide and ammonia, organic bases such as triethylamine and pyridine, metal alkoxides such as triisopropoxyaluminum, tetrabutoxyzirconium and tetrabutoxythitanate, and metal chelate compounds such as β-diketones and β-ketoesters. Specifically, there are illustrated, for example, compounds described in JP-A-2000-275403.

The content of the catalyst compound in the composition is 0.01 to 50% by weight, preferably 0.1 to 30% by weight, more preferably 0.5 to 10% by weight, based on the organometallic compound. It is preferred to properly adjust the reaction conditions.

It is also preferred for the matrix in the high refractive index layer or the film-forming curable compound to have a specific polar group which serves to maintain or improve the dispersing state of the composite oxide fine particles of the invention in the high refractive index layer. Examples of the specific polar group include an anionic group, an amino group and a quaternary ammonium group. As the anionic group, amino group and quaternary ammonium group, there are illustrated the same ones as the polar groups having been described with respect to the dispersing agent.

The matrix having the specific polar group for the high refractive index layer is obtained by, for example, compounding a dispersion containing the fine particles of the high refractive index composite oxide and the dispersing agent with a coating composition for forming the high refractive index layer, compounding with at least either of a combination of a binder precursor having a specific polar group (e.g., a curable poly-functional monomer or poly-functional oligomer having a specific polar group) and a polymerization initiator and an organosilicon compound having a specific polar group and a cross-linkable or polymerizable functional group and being represented by the general formula (1), and compounding, as desired, with a monofunctional monomer having a specific polar group and a cross-linkable or polymerizable functional group, then coating this composition on a transparent support, and causing cross-linking reaction or polymerization reaction among the dispersing agent, the mono-functional monomer, the poly-functional monomer or poly-functional oligomer and/or the organosilicon compound represented by the general formula (1).

In the coating composition, the mono-functional monomer having the specific polar group functions as a dispersing aid for the inorganic fine particles. Further, after coating the composition, the monomer having the specific polar group undergoes cross-linking reaction and/or polymerization reaction with the dispersing agent, the poly-functional monomer or the poly-functional oligomer to form the binder, whereby there results a high refractive index layer having excellent physical strength, chemical resistance and weatherability with maintaining good dispersibility of the fine inorganic particles in the high refractive index layer.

The content of the mono-functional monomer having an amino group or a quaternary ammonium group based on the dispersing agent is preferably 0.5 to 50% by weight, more preferably 1 to 30% by weight. Formation of the binder by cross-linking or polymerization reaction simultaneously with, or after coating of, the high refractive index layer permits the mono-functional monomer to effectively exert its function.

As another matrix for the high refractive index layer of the invention, there is illustrated that which corresponds to the organic binder (1) and which is formed by curing a conventionally known organic polymer having a cross-linkable or polymerizable group. It is preferred for the polymer to possess a further cross-linked or polymerized structure after formation of the high refractive index layer. Examples of the polymer include polyolefin (composed of saturated hydrocarbons), polyether, polyurea, polyurethane, polyester, polyamine, polyamide and melamine resin. Among them, polyolefin, polyether and polyurea are preferred, with polyolefin and polyether being more preferred. The weight-average molecular weight as an organic polymer before curing is preferably 1×10³ to 1×10⁶, more preferably 3×10³ to 1×10⁵.

On the other hand, the cured film containing the binder having the polar group can be formed by adding a monomer having the specific polar group to the curable coating composition, coating this composition on a transparent support, and causing cross-linking reaction or polymerization reaction with the dispersing agent, the poly-functional monomer or poly-functional oligomer, and the organometallic compound having the hydrolyzable functional group.

In the curable coating composition, the monomer having the specific polar group functions as a dispersing aid for the high refractive index composite oxide fine particles. Further, after coating the composition, the monomer having the specific polar group undergoes cross-linking reaction and/or polymerization reaction with the dispersing agent, the poly-functional monomer or the poly-functional oligomer to form the binder, whereby there results a cured film having excellent physical strength, chemical resistance and weatherability with maintaining good dispersibility of the fine particles.

Formation of the binder by cross-linking or polymerization reaction simultaneously with or after coating of the curable coating solution permits these monomers to effectively exerts their function before coating of the cured film.

The content of the monomer having an amino group or a quaternary ammonium group as the specific polar group based on the dispersing agent is preferably 0.5 to 50% by weight, more preferably 1 to 30% by weight.

Also, as the film-forming curable compound to be used in the invention, there are illustrated known organic polymers having a cross-linkable group or a polymerizable group in addition to the curable organic binders, organometallic compounds/and or the partial hydrolyzates thereof. Use of such polymer results in formation of a cured film wherein the polymer main chain has a cross-linked or polymerized structure. Examples of the polymer main chain include polyolefin (composed of saturated hydrocarbons), polyether, polyurea, polyurethane, polyester, polyamine, polyamide and melamine resin. Among them, polyolefin main chain, polyether main chain and polyurea main chain are preferred, with polyolefin main chain and polyether main chain which are obtained by addition polymerization of unsaturated polymerizable group being more preferred. The weight-average molecular weight as an organic polymer before curing is preferably 1×10³ to 1×10⁶, more preferably 3×10³ to 1×10⁵.

The organic polymer before being cured is preferably a copolymer having a repeating unit having the same specific polar group as is described with respect to the dispersing agent and a repeating unit having a cross-linked or polymerized structure. The content of the repeating unit having the anionic group in the polymer is preferably 0.5 to 99% by weight, more preferably 3 to 95% by weight, most preferably 6 to 90% by weight based on the whole repeating units. The repeating unit may have two or more, same or different, anionic groups.

When a repeating unit having a silanol group is contained, its content is preferably 2 to 98 mol %, more preferably 4 to 96 mol %, most preferably 6 to 94 mol %.

When a repeating unit having an amino group or a quaternary ammonium group is contained, its content is preferably 0.1 to 50 mol %, more preferably 0.5 to 30 mol %.

Additionally, the same effects can be obtained even when the aforesaid silanol group, the amino group or the quaternary ammonium group is contained in the repeating unit having the anionic group or the repeating unit having cross-linked structure or polymerized structure.

The content of the repeating unit having the cross-linked or polymerized structure in the polymer is preferably 1 to 90% by weight, more preferably 5 to 80% by weight, most preferably 8 to 60% by weight.

The matrix formed by cross-linkage or polymerization of the binder is preferably formed by coating a coating composition for forming the high refractive index layer on a transparent support, and causing the cross-linking or polymerization reaction simultaneously with or after the coating.

The high refractive index layer or curable coating composition of the invention may further contain proper other compounds depending upon use and purpose. For example, in the case of providing a low refractive index layer on the high refractive index layer, it is preferred for the refractive index of high refractive index layer to have a higher refractive index than that of the transparent support and, since incorporation of an aromatic ring, a halogen element other than fluorine (e.g., Br, I or Cl) or an atom such as S, N or P enhances the refractive index of an organic compound, a binder obtained by cross-linking or polymerization reaction of a curable compound containing them may preferably be used as well.

In order to form an antireflection film by forming a low refractive index layer on the high refractive index layer, the refractive index of the high refractive index layer is preferably 1.65 to 2.40, more preferably 1.75 to 2.20, particularly preferably 1.80 to 2.20.

To the high refractive index layer or curable coating composition may be added, resins, surfactants, antistatic agents, coupling agents, thickening agents, coloring-preventing agents, colorants (pigments and dyes), anti-foaming agents, leveling agents, fire retardants, UV ray absorbents, infrared ray absorbents, tackifiers, polymerization inhibitors, antioxidants, surface modifiers, and electrically conductive metal fine particles, in addition to the afore-mentioned components (e.g., inorganic fine particles, polymerization initiators and photo-sensitizers).

The high refractive index layer can also function as a glare-reducing layer to be described hereinafter having a glare-reducing ability by incorporating particles of 0.2 to 10 μm in average particle size.

The thickness of the high refractive index layer can properly be designed depending upon use. In the case of using the high refractive index layer as an optically interfering layer, the thickness is preferably 30 to 200 nm, more preferably 50 to 170 nm, particularly preferably 60 to 150 nm. In the case where the high refractive index layer also functions as a hard coat layer, the thickness is preferably 0.5 to 10 μm, more preferably 1 to 7 μm, particularly preferably 2 to 5 μm.

A coating solvent for the high refractive index layer is properly selected to use from water and organic solvents.

Examples of the organic solvents include alcohols, ketones, esters, amides, ethers, ether esters, hydrocarbons and halogenated hydrocarbons. Specifically, there are illustrated the same compounds as are described in the item of the dispersing agent. Preferred are coating solvents mainly containing a ketone solvent (e.g., methyl ethyl ketone, methyl isobutyl ketone or cyclohexanone), and the content of the ketone solvent is preferably 10% by weight or more based on the weight of the total solvents contained in the coating composition. The content is more preferably 30% by weight or more, still more preferably 60% by weight or more.

The strength of the high refractive index layer is preferably H or more, more preferably 2H or more, most preferably 3H or more, which is measured by the pencil hardness test according to JIS K5400.

Also, an abrasion amount of a test sample piece before and after Taber test according to JIS K5400 is preferably made as small as possible.

In the case where the high refractive index layer does not contain particles for imparting a glare-reducing ability, the haze of the layer is possibly made as small as possible. The haze is preferably 5% or less, more preferably 3% or less, particularly preferably 1% or less.

The high refractive index layer is preferably formed on the transparent support directly or via other layer.

In the invention, the high refractive index layer can be prepared by coating on the transparent substrate film the coating composition for forming the high refractive index layer according to a known thin film-forming method such as a dip-coating method, an air knife-coating method, a curtain coating method, a roller coating method, a wire bar-coating method, a gravure coating method, a microgravure coating method or an extrusion coating method, drying and irradiating with light and/or heating. Curing by irradiation with light is advantageous in view of rapid curing. Further, it is also preferred to heat-treat in the latter half of the photo-curing treatment.

(Formation of Cured Film)

The cured film of the invention is preferably formed directly, or via other layer, on the transparent support.

In the invention, the cured film can be prepared by coating on the transparent support film the curable coating composition of the invention according to a known film-forming method such as a dip-coating method, an air knife-coating method, a curtain coating method, a roller coating method, a wire bar-coating method, a gravure coating method, a microgravure coating method or an extrusion coating method, drying and irradiating with light or heat. Curing by irradiation with light is advantageous in view of rapid curing. Further, it is also preferred to heat-treat in the latter half of the photo-curing treatment.

As the light source for UV light to be used for the light irradiation, there are illustrated an ultra-high pressure mercury lamp, a high pressure mercury lamp, a middle pressure mercury lamp, a low pressure mercury lamp, a chemical lamp, a carbon arc lamp, a metal halide lamp, a xenon lamp, and sun light. There is illustrated multi-beamed irradiaition using various available laser light sources of 350 to 420 nm in wavelength.

In forming the cured film, the cross-linking reaction or the polymerization reaction of the ionizing radiation-curable compound is conducted preferably in an atmosphere of 10% by volume or less in oxygen concentration. Formation in an atmosphere of 10% by volume or less in oxygen atmosphere serves to improve physical strength, chemical resistance and weatherability of the cured film and, further, adhesion properties for a layer adjacent to the cured film. The oxygen concentration is more preferably 6% by volume or less, still more preferably 4% by volume or less, particularly preferably 2% by volume or less, most preferably 1% by volume or less.

As a technique for reducing the oxygen concentration to a level of 10% by volume or less, it is preferred to replace the atmosphere (nitrogen concentration: about 79% by volume; oxygen concentration: about 21% by volume) by other gas, preferably, nitrogen (purging with nitrogen).

The thickness of the cured film of the invention can properly be determined depending upon end use. In the case of using the cured film of the invention as an antireflection film to be described hereinafter, the thickness is preferably 30 to 200 nm, more preferably 50 to 170 nm, particularly preferably 60 to 150 nm. In the case where the cured film of the invention simultaneously functions as a hard coat layer, the thickness is preferably 0.5 to 10 μm, more preferably 1 to 7 μm, particularly preferably 2 to 5 μm. Also, the cured film of the invention can be incorporated with particles of 0.2 to 10 μm to be described hereinafter to simultaneously function as a glare-reducing layer.

The hardness of the cured film of the invention is preferably H or more when tested by the pencil hardness test according to JIS K5400, and a hardness of 2H or more is more preferred, with 3H or more being most preferred.

Also, the amount of abrasion measured on a test piece before and after Taber test according to JIS K5400 is preferably as small as possible.

When the cured film does not contain the particles for imparting glare-reducing function, it is preferred for the haze of the cured film to be as low as possible. It is preferably 5% or less, more preferably 3% or less, particularly preferably 1% or less.

The high refractive index layer or cured film of the invention is used for an antireflection film or a polarizing plate. In such uses, it is preferred to provide an outermost layer having antiscratching properties and stainproofing proerties on the high refractive index layer side or the cured film side. The outermost layer is described below.

As means for improving the antiscratching properties, it is effective to impart slipping properties to the surface of the layer, and known means such as introduction of silicon-containing compound or fluorine-containing compound into the outermost layer may be employed.

The fluorine-containing compound has a refractive index of preferably 1.35 to 1.50, more preferably 1.36 to 1.47. Also, the fluorine-containing compound contains fluorine atom in a content of 35 to 80% by weight.

Examples of the fluorine-containing compound include a fluorine-containing polymer, a fluorine-containing surfactant, a fluorine-containing ether and a fluorine-containing silane compound. Specifically, there are illustrated, for example, compounds described in JP-A-9-222503, paragraphs [00181] to [0026], JP-A-11-38202, paragraphs [0019] to [0030], and JP-A-2001-40284, paragraphs [0027] to [0028].

As the fluorine-containing polymer, a copolymer comprising a repeating structural unit containing fluorine atom, a repeating structural unit containing a cross-linkable or polymerizable functional group, and a repeating unit comprising other substituent (hereinafter referred to as “other repeating structural unit”) is preferred. As the cross-linkable or polymerizable functional group, there are illustrated the same ones as those with the high refractive index layer. As other repeating structural unit, a hydrocarbon series copolymerizable component is preferred for acquiring dissolving properties in a coating solvent. Fluorine-containing polymers having introduced thereinto about 50% of such component are preferred. In this occasion, it is preferred to combine with a silicone compound.

As such silicone compound, those compounds are preferred which have a polysiloxane structure, contain a curable functional group or a polymerizable functional group in the high polymer chain, and have a bridging structure in the film. For example, there are illustrated reactive silicones such as commercially available Saila Plane (made by, e.g., Chisso K.K.) and a comound described in JP-A-11-258403 wherein silanol groups are bound to both ends of the polysiloxane structure.

Cross-linking or polymerizing reaction of the fluorine-containing polymer having a cross-linkable or polymerizable group is conducted preferably by irradiating with light or by heating simultaneously with or after coating of a coating composition for forming the outermost layer. As the polymerization initiator and the sensitizing agent, there are illustrated the same ones as are used for the high refractive index layer.

As the matrix for the high refractive index layer or cured film, a sol-gel cured product is also preferred that is obtained by condensation reaction between a silane coupling agent (e.g., a compound of the foregoing general formula (1)) and a silane coupling agent having a specific fluorine-containing hydrocarbonic group.

For example, there are illustrated polyfluoroalkyl group-containing silane compounds or the partially hydrolyzed condensates thereof (e.g., compounds described in JP-A-58-142958, JP-A-58-147483 and JP-A-58-147484), perfluoroalkyl group-containing silane coupling agents described in JP-A-9-157582, and silyl compounds containing a fluorine-containing long-chain group of poly“perfluoroalkyl ether” group (e.g., compounds described in JP-A=2000-117902, JP-A-2001-48590 and JP-A-2002-53804).

As a catalyst to be used here, there are illustrated those which have been described with respect to the high refractive index layer.

In addition to the above-described components, the outermost layer can contain fillers (e.g., inorganic fine particles and organic fine particles), silane coupling agents, slip agents (e.g., silicone compounds such as dimethylsilicone), and surfactants. Especially, it is preferred to incorporate inorganic fine particles, silane coupling agents or slip agents.

As the inorganic fine particles, compounds with a low refractive index such as fluorine-containing particles (e.g., magnesium fluoride, calcium fluoride or barium fluoride) are preferred. Particularly preferred is silicon dioxide (silica). The weight-average particle size of primary particles of the inorganic fine particles is preferably 1 to 150 nm, more preferably 1 to 100 nm. In the outermost layer, the particles are preferably dispersed more finely.

The outermost layer of the invention has a surface kinetic friction coefficient of preferably 0.25 or less. The kinetic friction coefficient as used herein means a kinetic friction coefficient between the surface and a stainless steel ball of 5 mm in diameter measured by moving the steel ball along the surface at a speed of 60 cm/min while applying a load of 0.98 N to the steel ball. The kinetic friction coefficient is preferably 0.17 or less, particularly preferably 0.15 or less.

Also, the contact angle of the outermost surface to water is preferably 90° or more, more preferably 95° or more, particularly preferably 100° or more.

[Antireflection Film]

The high refractions index layer or cured film of the invention can preferably be utilized for forming an antireflection film. More specifically, the high refractive index layer or cured film of the invention can be used as one layer in a multi-layer antireflection film formed by laminating two or more layers having light-transmitting properties and being different from each other in refractive index (light-transmitting layers). The high refractive index layer or cured film of the invention is mainly used as a high refractive index layer or a middle refractive index layer of an antireflection film, and also may be used as a high refractive hard coat layer or a high refractive glare-reducing layer. Additionally, in the multi-layer antireflection film, a layer having the highest refractive index is referred to as a high refractive index layer, a layer having the lowest refractive index is referred to as a low refractive index layer, and other layer having a middle refractive index layer is referred to as a middle refractive index layer. The middle refractive index layer of the antireflection layer may be a layer constituted by the high refractive index film formed from the curable coating composition of the invention.

When the antireflection film of the invention does not have the glare-reducing function, its haze is preferably as low as possible. When the antireflection film has the glare-reducing function, its haze is preferably 0.5 to 50%, more preferably 1 to 40%, most preferably 1 to 30%.

(Low Refractive Index Layer)

The low refractive index layer may also function as the outermost layer or may be under the outermost layer.

In the case where the low refractive index layer also functions as the outermost layer, descriptions having been described hereinbefore with respect to the outermost layer may be applied as well. In the case where the low refractive index layer is under the outermost layer, the low refractive index layer preferably contains a silicon-containing compound.

Also, the refractive index of the low refractive index layer is 1.20 to 1.55, preferably 1.30 to 1.50, more preferably 1.35 to 1.48, particularly preferably 1.40 to 1.48.

When the low refractive index layer is provided under the outermost layer, it can be formed by a coating method or a gas phase method (e.g., a vacuum deposition method, a sputtering method, anion-plating method or a plasma CVD method). The coating method is preferred due to its inexpensiveness for the production. The thickness of the low refractive index layer is preferably 30 to 200 nm, more preferably 50 to 150 nm, most preferably 60 to 120 nm.

When the low refractive index layer does not contain the particles for imparting glare-reducing function, it is preferred for the haze of the cured film to be as low as possible. The haze value is preferably 5% or less, more preferably 3% or less, particularly preferably 1% or less.

The hardness of the low refractive index layer is preferably H or more when tested by the pencil hardness test according to JIS K5400, and a hardness of 2H or more is more preferred, with 3H or more being most preferred.

Also, as to the amount of abrasion measured by Taber test according to JIS K5400, kinetic friction coefficient, and contact angle for water, the same properties as that of the outer layer are preferred.

Additionally, when the low refractive index layer is provided under the outermost layer, the low refractive index layer preferably contains a silicon compound.

(Hard Coat Layer)

The hard coat layer is provided on the surface of a transparent support in order to impart sufficient physical strength to the antireflection film. In particular, it is preferably provided between the transparent support and the high refractive index layer.

The hard coat layer is preferably formed by cross-linking reaction or polymerization reaction of a photo- and/or heat-curable compound. For example, it can be formed by coating on a transparent support a coating composition containing polyester (meth)acrylate, polyurethane (meth)acrylate, poly-functional monomer or poly-functional oligomer or an organometallaic compound containing a hydrolysable functional group, and causing cross-linking reaction or polymerization reaction of the curable compound.

As the curable functional group contained in the curable compound, a photo-polymerizable functional group is preferred, and the organometallic compound having a hydrolysable functional group is preferably an organic alkoxysilyl compound.

Specific examples of these compounds are those having been illustrated with respect to the high refractive index layer.

The hard coat layer preferably contains inorganic fine particles of 300 nm or less in average particle size of primary particles. More preferred inorganic fine particles have the size of 10 to 150 nm, and still more preferred inorganic fine particles have the size of 20 to 100 nm. Here, the average particle size means the weight-average particle size. A hard coat layer having a non-spoiled transparency can be formed by adjusting the average particle size of the primary particles to 200 nm or less.

The inorganic fine particles functions to enhance hardness of the hard coat layer and, at the same time, functions to depress cure shrinkage of the coated layer. Also, they are added for the purpose of controlling refractive index of the hard coat layer.

As to specific structural composition of the hard coat layer, reference may be made to descriptions given in JP-A-2002-144913, JP-A-2000-9908, WOo/46617, etc.

The content of the inorganic fine particles in the hard coat layer is preferably 10 to 90% by weight, more preferably 15 to 80% by weight, based on the whole weight of the hard coat layer.

As has been described hereinbefore, the high refractive index layer of the antireflection film can exert function of the hard coat layer. When the high refractive index layer exerts function of the hard coat layer as well, it is preferred to form the layer by incorporating in the hard coat layer the fine particles of the composite oxide finely dispersed using the technique described with respect to the high refractive index layer of the invention.

Further, particles of 0.2 to 10 μm in average particle size to be described hereinafter may be incorporated in the hard coat layer to impart function of the glare-reducing agent having glare-reducing properties.

The thickness of the hard coat layer can properly be designed depending upon the end use. The thickness of the hard coat layer is preferably 0.2 to 10 μm, more preferably 0.5 to 7 μm, particularly preferably 0.7 to 5 μm.

The hardness of the hard coat layer is preferably H or more when tested by the pencil hardness test according to JIS K5400, and a hardness of 2H or more is more preferred, with 3H or more being most preferred.

Also, the amount of abrasion measured on a test piece before and after Taber test according to JIS K5400 is preferably as small as possible.

(Transparent Support)

The transparent support is preferably a plastic film. The thickness of the transparent support is not particularly limited, but is preferably 1 to 300 μm, more preferably 30 to 150 μm, still more preferably 40 to 120 μm. The light transmission of the transparent support is preferably 80% or more, more preferably 86% or more. The haze of the transparent support is preferably 2.0% or less, more preferably 1.0% or less. The refractive index of the transparent support is preferably 1.4 to 1.7.

Examples of the plastic film which constitutes the transparent support include a cellulose ester (e.g., triacetyl cellulose, diacetyl cellulose, propionyl cellulose, butyryl cellulose, acetylpropionyl cellulose or nitrocellulose), a polyamide, a polycarbonate, a polyester (e.g., polyethylene terephthalate, polyethylene naphthalate, poly-1,4-cyclohexanedimethylene terephthalate, polyethylene 1,2-diphenoxyethane-4,4′-dicarboxylate or polybutylene terephthalate), a polystyrene (e.g., syndiotactic polystyrene), a polyolefin (e.g., polypropylene, polyethylene or polymethylpentene), a polysulfone, a polyether sulfone, a polyallylate, a polyetherimide, a polymethyl methacrylate and a polyether ketone. Among them, triacetyl cellulose, polycarbonate, polyethylene terephthalate and polyethylene naphthalate are preferred. Particularly, in the case of using in a liquid crystal display device, triacetyl cellulose is preferred.

When the transparent support is a triacetyl cellulose film, the triacetyl cellulose film is preferably obtained by a casting method of either casting a single layer or co-casting a plurality of layers of a triacetyl cellulose dope prepared by dissolving triacetyl cellulose in a solvent. As a filming method, there may be employed, for example, the method described in Hatsumei Kyokai Kokai Giho (Kogi No. 2001-1745, published by Hatsumei Kyokai on 15, March 2001), pp. 22 to 30.

To the transparent support may be added various additives (e.g., plasticizers, fine particles, UV ray-protecting agents, deterioration-preventing agents, optical anisotropy-controlling agents, peeling agents, and infrared ray absorbents) depending upon end use. The amount of each of these additives is preferably 0.01 to 20% by weight, more preferably 0.05 to 10% by weight, based on the transparent support. Detail descriptions on them are given in Hatsumei Kyokai Kokai Giho (Kogi No. 2001-1745, published by Hatsumei Kyokai on 15, March 2001), pp. 16 to 22, and materials described there are preferably used.

The transparent support may be subjected to surface treatment. Examples of the surface treatment include chemical treatment, mechanical treatment, corona discharge treatment, flame treatment, UV ray-irradiating treatment, high frequency treatment, glow discharge treatment, active plasma treatment, laser treatment, acid treatment, ozone oxidation treatment and alkali treatment. Glow discharge treatment, UV ray-irradiating treatment, corona discharge treatment and flame treatment are preferred, with glow discharge treatment, corona discharge treatment and alkali treatment being particularly preferred.

(Other Layers in the Antireflection Film)

In order to form an antireflection film having better antireflection properties, it is preferred to provide a middle refractive index layer having a refractive index between the refractive index of the high refractive index layer and the refractive index of the transparent support between the transparent support and the high refractive index layer.

The middle refractive index layer is prepared preferably in the same manner as described with the high refractive index layer of the invention, with the refractive index being adjusted by controlling the content of inorganic fine particles in the layer.

In the antireflection layer may be provided other layers than are described hereinbefore. For example, there may be provided an adhesive layer, a shield layer, a slipping layer, an antistatic layer and a primer layer. The shield layer is provided for shielding from an electromagnetic wave or infrared rays.

Also, in the case of using the antireflection film in a liquid crystal display device, an undercoat layer containing particles of 0.1 to 10 μm in average particle size may be provided for the purpose of improving viewing angle characteristics. The term “average particle size” as used herein means a weight-average particle size of secondary particles (or, when particles are not agglomerated, primary particles). The average particle size of the particles is preferably 0.2 to 5.0 m, more preferably 0.3 to 4.0 μm. As such particles, there are illustrated the inorganic particles and organic particles to be used in a glare-reducing layer.

The refractive index of the particles is preferably 1.35 to 1.80, more preferably 1.40 to 1.75.

The undercoat is preferably formed between the hard coat layer and the transparent support. It is also possible for the undercoat layer to exert the function of the hard coat layer.

In the case of adding particles of 0.1 to 10 μm in average particle size to the undercoat layer, the haze of the undercoat layer is preferably 3 to 60%, more preferably 5 to 50%.

(Method for Forming Antireflection Film)

In the invention, each of the layers constituting the antireflection film is preferably formed by coating method. In forming by the coating method, each layer can be formed according to the coating method having been described with respect to the high refractive index layer. It is also possible to coat two or more layers at the same time. (described in, for example, Coating Kogaku written by Yuji Harazaki and published by Asakura Shoten in 1973, p. 253. As the coating method, wire bar coating method, gravure coating method, and microgravure coating method are preferred.

Also, to each of the layers of the antireflection layer may be added other compounds such as resins, dispersing agents, surfactants, antistatic agents, thickening agents, coloring-preventing agents, colorants (pigments and dyes), anti-foaming agents, leveling agents, fire retardants, UV ray absorbents, tackifiers, polymerization inhibitors, antioxidants, and surface modifiers depending upon use and purpose.

(Physical Properties of the Antireflection Film)

In the invention, the outermost surface of the antireflection film on the high refractive index layer side has a surface kinetic friction coefficient of preferably 0.25 or less. The kinetic friction coefficient as used herein means a kinetic friction coefficient between the surface on the high refractive index layer side and a stainless steel ball of 5 mm in diameter measured by moving the steel ball along the surface at a speed of 60 cm/min while applying a load of 0.98 N to the steel ball. The kinetic friction coefficient is preferably 0.17 or less, particularly preferably 0.15 or less.

Also, the contact angle of the antireflection film on the high refractive index layer side to water is preferably 90° or more, more preferably 95° or more, particularly preferably 100° or more.

In the case where the antireflection film does not have the glare-reducing ability, it has preferably a haze as low as possible.

In the case where the antireflection film has the glare-reducing ability, its haze is preferably 0.5 to 50%, more preferably 1 to 40%, most preferably 1 to 30%.

(Surface Unevenness of Antireflection Film)

It is possible to form unevenness on the surface of the high refractive index layer side of the antireflection film of the invention to impart glare-reducing properties.

The glare-reducing properties correlate with the average surface roughness (Ra) of the surface. The unevenness of the surface is preferably 0.01 to 0.4 μm, more preferably 0.03 to 0.3 μm, still more preferably 0.05 to 0.25 μm, particularly preferably 0.07 to 0.2 μm, in terms of the average surface roughness (Ra) for an area of 1 mm² of the surface taken out at random from an area of 100 cm² of the surface.

As to the average surface roughness (Ra), descriptions are given in Technocompact Series (6), Hyomen Arasa No Sokutei•Hyoka Ho, written by Jiro Nara and published by K.K. Sogo Gijutsu Center.

Shapes of the recess and projection on the surface of the antireflection film of the invention can be evaluated by means of an atom-to-atom force microscope (AFM).

As the method for forming the unevenness of the surface, known methods may be employed. In the invention, a method of forming unevenness by pressing a plate having the uneven surface with a high pressure to the surface of the film (e.g., embossing described in JP-A-2000-329905) and a method of forming unevenness on the surface of the antireflection film by incorporating particles in any of the layers on the antireflection film to form a glare-reducing layer are preferred.

In forming a glare-reducing layer by incorporating particles in any of the layers of the antireflection film, the particles to be used have an average particle size of 0.2 to 10 μm. The term “average particle size” as used herein means a weight-average particle size of secondary particles (or, when the particles are not agglomerated, primary particles).

As the particles, there are illustrated inorganic particles and organic particles. Specific examples thereof include compounds described in JP-A-2001-33625, paragraph [0014].

The refractive index of the particles is preferably 1.35 to 1.80, more preferably 1.40 to 1.75, more preferably 1.45 to 1.75.

The particles for imparting glare-reducing properties may be incorporated in any of the layers formed on the antireflection film, preferably the hard coat layer, the lowly reflective layer or the high refractive index layer, particularly preferably the hard coat layer or the high refractive index layer. They may be added to a plurality of layers.

[Constitution of Antireflection Film]

The high refractive index layer in accordance with the invention constitutes one or more layers of the multi-layer antireflection film having light-transmitting properties and comprising two or more laminated layers different from each other in refractive index (light-transmitting layers).

The antireflection film comprising two laminated layers has a stratum structure of a transparent support, high refractive index layer, and low refractive index layer (outermost layer) in this order. The transparent support, high refractive index layer and low refractive index layer have a refractive index satisfying the following relation:

Refractive index of high refractive index layer>refractive index of transparent support>refractive index of low refractive index layer

It is also possible to provide a hard coat layer between the transparent support and the high refractive layer. Further, the film may comprise the high refractive hard coat layer or high refractive glare-reducing layer and the low refractive index layer.

The antireflection film comprising at least three laminated layers has a stratum structure of a transparent support, middle refractive index layer, high refractive index layer, and low refractive index layer (outermost layer) in this order. The transparent support, middle refractive index layer, high refractive index layer and low refractive index layer have a refractive index satisfying the following relation:

Refractive index of high refractive index layer>refractive index of middle refractive index layer>refractive index of transparent support>refractive index of low refractive index layer

It is also possible to provide a hard coat layer between the transparent support and the middle refractive index layer. Further, the film may comprise the middle refractive hard coat layer, high refractive index layer and the low refractive index layer.

In view of forming an antireflection film having more excellent antireflection ability, it is preferred for each of the layers in the multi-layer structure to have the relation between thickness of each layer and wavelength of visible light as described in JP-A-2001-188104.

Additionally, the terms “high refractive”, “middle refractive”, and “low refractive” mean the relative higher or lower relation between the layers.

It is also preferred to form an antireflection film having a glare-reducing ability by incorporating particles of 0.2 to 10 μm in average particle size in the hard coat layer, the middle refractive index layer or the high refractive index layer.

Also, when the low refractive index layer comprises an inorganic compound layer, it is preferred to provide the stain-proofing layer as the uppermost layer.

[Polarizing Plate]

A preferred polarizing plate of the invention has the antireflection film of the invention as at least one of protective films for the polarizing plate. As has been described hereinbefore, the protective film for the polarizing plate has a contact angle to water of 40° or less as to the surface of the transparent support which is opposite to the side of the high refractive index layer, that is, the surface to be laminated on the polarizing film.

A polarizing plate having antireflection ability can be formed by using the antireflection film of the invention as a protective film for the polarizing plate, which enables one to greatly reduce production cost and thickness of the display device.

Also, a polarizing plate which serves to more improve contrast of a liquid crystal display device in a bright room can be obtained by forming a polarizing plate using the antireflection film of the invention as one protective film for the polarizing plate and an optically compensation film to be described hereinafter which has an optical anisotropy as another protective film for the polarizing plate. Such polarizing plate has remarkably widened upper, lower, left and right viewing angles.

(Protective Film for Polarizing Plate)

In the case of using the antireflection film of the invention as a protective film for polarizing film, it is preferred to make the contact angle of the surface of the transparent support opposite to the high refractive index layer side 40° or less for obtaining sufficient adhesiveness to the polarizing film.

In this case, it is particularly preferred to use a triacetyl cellulose film as the transparent support.

As methods for forming the protective film for polarizing plate of the invention, there are illustrated the following two methods:

(1) a method of coating each of the above-described layers (e.g., high refractive index layer, hard coat layer, and outermost layer) on one side of the saponification-treated transparent support; and

(2) a method of coating each of the above-described layers (e.g., high refractive index layer, hard coat layer, and outermost layer) on one side of the transparent support, and saponification-treating the side on which the polarizing film is to be laminated.

Further, it is also possible to coat a saponification-treating solution on the surface of the transparent support of the antireflection film to be laminated with the polarizing film to thereby conduct saponification treatment of the surface to be laminated with the polarizing film.

The hydrophilicity-imparting treatment for the surface of the antireflection film of the invention can be conducted in a known manner. For example, it is preferred to dip the transparent support or the antireflection film in an alkaline solution for a proper period of time or coat an alkaline solution on them to thereby conduct saponification treatment.

As to the alkaline solution and treating method, reference may be made to descriptions given in JP-A-2002-82226 and WO02/46809. The treatment is preferably conducted in such manner that the contact angle of the saponification-treated film surface becomes 45° or less.

The thus hydrophilicity-imparted surface of the protective film for polarizing plate is adhered to the polarizing film to use.

As to optical performance (e.g., antireflecting ability and glare-reducing ability), physical performance (e.g., antiscratching properties), chemical resistance, stain-proofing properties (e.g., resistance to stains), and weatherability (e.g., resistance to moist heat, and resistance to light), it is preferred for the protective film for polarizing plate to have the performance described with respect to the antireflection film of the invention.

(Optically Compensation Film)

An optically compensation film (retardation film) can improve viewing angle characteristics of a liquid crystal display device.

As the optically compensation film, known ones may be used but, in view of widening viewing angle, an optically compensation film described in JP-A-2001-100042 which has an optically anisotropic layer comprising a compound having a discotic structural unit and wherein the angle between the discotic compound and the support is varied in the depth direction is preferred.

Also, the angle preferably changes so that it increases with the increase in the distance from the support side of the optically anisotropic layer.

In the case of using the optically compensation film as a protective film for polarizing film, the surface to be laminated with the polarizing film is preferably saponification-treated. Such treatment is preferably conducted according to the aforesaid saponification treatment with alkali.

Also, an embodiment wherein the optically anisotropic layer further contains cellulose ester and an embodiment wherein an orienting layer is formed between the optically anisotropic layer and the transparent support are preferred as well.

[Image Display Device]

The antireflection film can find application to image display devices such as a liquid crystal display device (LCD), a plasma display panel (PDP), an electroluminescence display (ELD) and a cathode ray tube display device (CRT). The transparent support side of the antireflection film is adhered to the image display side of the image display device.

The antireflection film and the polarizing plate of the invention are preferably usable in transmission type, reflection type or semi-transmission type liquid crystal display devices of such mode as twisted nematic (TN) mode, supertwisted nematic (STN) mode, vertical alignment (VA) mode, in-plane switching (IPS) mode, or optically compensated bend cell (OCB) mode.

Also, in the case of using in transmission type or semi-transmission type liquid crystal display devices, use of a commercially available luminance-improving film (polarization-separating film having a polarized light-selecting layer, e.g., D-BEF made by Sumitomo 3M K.K.) can provide a display device giving higher visibility.

Also, when used in combination with a λ/4 plate, the polarizing plate or the antireflection film of the invention can be used as a polarizing plate in a reflection type liquid crystal display device or as a surface-protecting plate for an organic EL display for reducing a reflected light from the surface and the interior.

### EXAMPLES

The invention is described more specifically below.

However, the invention should not be construed as being limited thereto.

### Example 1-1

(Preparation of a Coating Solution for Hard Coat Layer)

450.0 g of a dispersion of silica fine particles in methyl ethyl ketone (MEK-ST; content of solid component: 30% by weight; made by Nissan Kagaku K.K.), 15.0 g of methyl ethyl ketone, 220.0 g of cyclohexanone and 16.0 g of a photo polymerization initiator (Irgacure 907; made by Nihon Ciba Geigy K.K.) were added to 315.0 g of a mixture of dipentaerythritol pentaacrylate and dipentaerythritol hexaacrylate (DPHA; made by Nihon Kayaku K.K.), and the resulting mixture was stirred. The stirred mixture was filtered through a polypropylene-made filter of 0.4 μm in pore size to prepare a coating solution for a hard coat layer.

(Preparation of a Dispersion of High Refractive Index Composite Oxide Fine Particles (PL1-1))

38.6 g of a dispersing agent (D-1) of the following structure, 0.5 g of a polymerization inhibitor of t-butylhydroquinone, and 702 g of methyl isobutyl ketone were added to 218 g of composite oxide of Ti and Zr [Ti/Ti+Zr=0.80 by weight ratio (in terms of oxides) containing doped Co ion in a content of 3% by weight (P-1), and the mixture was dispersed in a dynomil to prepare a dispersion (PL-1) of fine particles of high refractive index composite oxide having a weght-average particle size of 65 nm.
Dispersing Agent

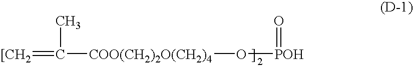

(Preparation of a Coating Solution for Middle Refractive Index Layer)

58.4 g of DPHA, 3.1 g of Irgacure 907, 1.1 g of a photo sensitizing agent (Kayacure DETX, made by Nihon Kayaku K.K.), 482.4 g of methyl ethyl ketone and 1869.8 g of cyclohexanone were added to 88.9 g of the above-described dispersion of high refractive index composite oxide fine particles (PL1-1), followed by stirring. The stirred mixture was filtered through a filter made of polypropylene of 0.4 μm in pore size to prepare a coating solution for a middle refractive index layer.

(Preparation of a Coating Solution for High Refractive Index Layer)

47.9 g of DPHA, 4.0 g of Irgacure 907, 1.3 g of Kayacure DETX, 455.8 g of methyl ethyl ketone and 1427.8 g of cyclohexanone were added to 586.8 g of the above-described dispersion of high refractive index composite oxide fine particles (PL1-1), followed by stirring. The stirred mixture was filtered through a filter made of polypropylene of 0.4 μm in pore size to prepare a coating solution for a high refractive index layer.

(Preparation of a Coating Solution for Low Refractive Index Layer)

The solvent of a thermally cross-linkable, fluorine-containing polymer of 1.42 in refractive index (Opster JN7228; content of solid components: 6% by weight; made by JSR K.K.) was replaced to obtain a solution of the thermally cross-linkable, fluorine-containing polymer in methyl isobutyl ketone having a solid component concentration of 10% by weight. To 56.0 g of the thermally cross-linkable, fluorine-containing polymer solution were added 8.0 g of a dispersion of silica fine particles in methyl ethyl ketone (MEK-ST; content of solid component: 30% by weight; made by Nissan Kagaku K.K.), 1.75 g of the following silane compound, 73.0 g of methyl isobutyl ketone and 33.0 g of cyclohexanone, followed by stirring. The stirred mixture was filtered through a filter made of polypropylene of 0.4 μm in pore size to prepare a coating solution for a low refractive index layer.

(Preparation of a Silane Compound)

161 g of 3-acryloxypropyltrimethoxysilane (KBM-5103; made by Shin-etsu Kagaku Kogyo K. K.), 123 g of oxalic acid and 415 g of ethanol were added to a reactor equipped with a stirrer and a reflux condenser and, after reacting at 70° C. for 4 hours, the reaction mixture was cooled to room temperature to obtain a silane compound as a curable composition.

(Preparation of an Antireflection Film)

The coating solution for hard coat layer was coated on a 80 μm-thick triacetyl cellulose film (TD-80UF; made by Fuji Photo Film Co., Ltd.) using a gravure coater. After drying at 100° C., the coated layer was irradiated with ultraviolet rays with an intensity of 400 mW/cm² and an irradiation amount of 300 mJ/cm² using a 160 W/cm air-cooled metal halide lump (made by Ai Graphics K.K), while purging the atmosphere with nitrogen so that the oxygen concentration of the atmosphere was kept at a level of 1.0% by volume or less, to thereby cure the coated layer. Thus, there was formed a 3.5 μm-thick hard coat layer.

On the hard coat layer was coated the coating solution for middle refractive index layer using a gravure coater. After drying at 100° C., the coated layer was irradiated with ultraviolet rays with an intensity of 550 mW/cm² and an irradiation amount of 600 mJ/cm² using a 240 W/cm air-cooled metal halide lump (made by Ai Graphics K.K), while purging the atmosphere with nitrogen so that the oxygen concentration of the atmosphere was kept at a level of 1.0% by volume or less, to thereby cure the coated layer. Thus, there was formed a middle refractive index layer (refractive index: 1.65; thickness: 67 nm).

On the middle refractive index layer was coated the coating solution for high refractive index layer using a gravure coater. After drying at 100° C., the coated layer was irradiated with ultraviolet rays with an intensity of 550 mW/cm² and an irradiation amount of 600 mJ/cm² using a 240 W/cm air-cooled metal halide lump (made by Ai Graphics K.K), while purging the atmosphere with nitrogen so that the oxygen concentration of the atmosphere was kept at a level of 1.0% by volume or less, to thereby cure the coated layer. Thus, there was formed a high refractive index layer (refractive index: 1.96; thickness: 105 nm).

On the high refractive index layer was coated the coating solution for low refractive index layer using a gravure coater. After drying at 80° C., the coated layer was irradiated with ultraviolet rays with an intensity of 550 mW/cm² and an irradiation amount of 600 mJ/cm² using a 160 W/cm air-cooled metal halide lump (made by Ai Graphics K.K) and heated at 120° C. for 10 minutes, while purging the atmosphere with nitrogen so that the oxygen concentration of the atmosphere was kept at a level of 1.0% by volume or less, to thereby form a low refractive index layer (refractive index: 1.43; thickness: 68 nm). Thus, there was formed an antireflection film.

### Comparative Example 1-A

An antireflection film was prepared in absolutely the same manner as in Example 1 except for using fine particles of composite oxide of Ti and Zr [Ti/Ti+Zr=0.80] having been surface-treated with aluminum oxide and stearic acid in place of the composite oxide fine particles of Exmple 1-1.

(Evaluation of the Antireflection Film)

Each of the thus-prepared antireflection films was evaluated on the following items. Results are tabulated in Table 1.

(1) Evaluation of Haze

The haze of each antireflection film was evaluated using a haze meter (NHD-1001DP; made by Nihon Denshoku Kogyo K.K.).

(2) Evaluation of Reflectivity

The spectral reflectivity was measured at an incident angle of 5° in a wavelength region of 380 to 780 nm using a spectrophotometer (V-550, ARV-474; made by Nihon Bunko K.K.). An average refractivity in a wavelength range of 450 to 650 nm was determined.

(3) Weathering Test

A weathering test was conducted under the conditions of sun shine carbon arc lamp in light source, 60% in relative humidity, and 100 hours in testing period using a sunshine weathermeter (S-80; made by Suga Shikenki K.K.). The whitening degree of the antireflection film before and after the exposure was observed and evaluated according to the following three grades:

A: No whitening was observed visually.

B: Whitening was visually observed a little.

C: Serious whitening was observed visually.

(4) Evaluation of Adhesion

Each of the antireflection films having been exposed in the test (3) was subjected to moisture conditioning under the conditions of 25° C. in temperature and 60% in relative humidity.

Notches were formed in a lattice pattern on the surface of the high refractive index layer side of each antireflection film using a cutter knife, with 11 notches in the longitudinal directions and 11 notches in the transverse directions, thus forming a total of 100 square areas surrounded by the notches, and an adhesion test using a polyester-made adhesive tape made by Nitto Denko K.K. (NO. 31B) was repeatedly conducted 3 times at the same position. Occurrence of delamination was visually observed and evaluated according to the following 4 grades:

◯◯: Absolutely no delamination was observed with the 100 pieces.

◯: Delamination was observed with 2 or less pieces out of 100 pieces.

Δ: Delamination was observed with 10 to 3 pieces out of 100 pieces.

X: Delamination was observed with more than 10 pieces out of 100 pieces.

(5) Evaluation of Pencil Hardness

After subjecting the antireflection films before and after the exposure were subjected to moisture conditioning under the conditions of 25° C. in temperature and 60% in relative humidity, and were evaluated in terms of pencil hardness under a load of 1 kg according to the evaluating method for pencil hardness described in JIS K5400 using a testing pencil specified by JIS S6006.

(6) Evaluation of Resistance to Scratching with Steel Wool

The state of scratches, formed when the antireflection films before and after the exposure were scratched 10 reciprocations by #0000 steel wool under a load of 1 Kg/cm², was observed and evaluated according to the following three grades:

A: Absolutely no scratches was formed.

B: Scratches were formed a little, though difficult to observe.

C: Serious scratches were formed.

TABLE 1

| | | Example | Comparative |
|---|---|---|---|
| | | 1-1 | Ex. 1-A |
| Haze | | 0.3% | 0.3% |
| Reflectivity | | 1.0% | 1.1% |
| Weather- | Before exposure | A | A |
| ability | After exposure | A | C |
| Adhesion | After exposure | ◯◯ | X |
| Pencil | After exposure | 3H | less than 1H |
| hardness | | | |
| Scratching | After exposure | A | C |
| resistance | | | |

Samples obtained in Example 1-1 and Comparative Example 1-A before the exposure test using the fedeometer were good in optical properties and mechanical strength as an antireflection film.

Further, evaluation of the samples after the weathering test revealed that the sample of Example 1-1 showed no whitening of film and kept the performance before the test with respect to the items of adhesion, pencil hardness and scratching resistance.

On the other hand, the sample obtained in Comparative Example 1-A suffered serious whitening of film, and suffered deterioration with respect to adhesion, pencil hardness and scratching resistance, thus being found not to be practically usable.

As is described above, the film sample of the invention showed extremely excellent weatherability, thus being a good antireflection film.

Further, the contact angle of the surface of the antireflection film of the invention for water was 101°, and the kinetic friction coefficient was 0.08. Measurement thereof were conducted in the following manner.

(7) Evaluation of Contact Angle

Samples were subjected to moisture conditioning under the conditions of 25° C. in temperature and 60% in relative humidity for 2 hours. The contact angle of the surface of the antireflection film on the low refractive index layer side for water was evaluated.

(8) Evaluation of Kinetic Friction Coefficient

As an indicator for slipping property of the surface of the antireflection film on the low refractive index layer side, kinetic friction coefficient was evaluated. The kinetic fraction coefficient was measured under using a kinetic friction coefficient-measuring machine (HEIDON-14) and stainless steel ball of 5 mm in diameter under a load of 100 g at a speed of 60 cm/min after subjecting a sample to moisture conditioning under the conditions of 25° C. in temperature and 60% in relative humidity for 2 hours.

### Example 1-2 to Example 1-4

Antireflection films were prepared in the same manner as in Example 1-1 except for using respective dispersions of high refractive index composite oxide fine particles (PL1-2 to PL1-4) in place of the dispersion of high refractive index composite oxide fine particles (PL1-1).

Additionally, average particle size of dispersed particles in the dispersions of respective high refractive index composite oxide fine particles (PL1-2 to PL1-4) was within a range of from 60 to 90 nm, and the particles showed good monodispersing properties.

TABLE 2

| | Disper- | | | |
|---|---|---|---|---|
| | sion | Fine | | |
| | of | Particles | Doped | |
| | Com- | of | Metal | |
| | posite | Composite | Ion: | |
| Ex- | Oxide | Oxide | Doped | |
| am- | Fine | (weight | amount | |
| ple | Particle | ratio) | (wt %) | Dispersing Agent (weight ratio) |
| 1-2 | PL1-2 | composite oxide of titanium and zirconium; content of Ti: 0.85 | Co ion 1.5% | 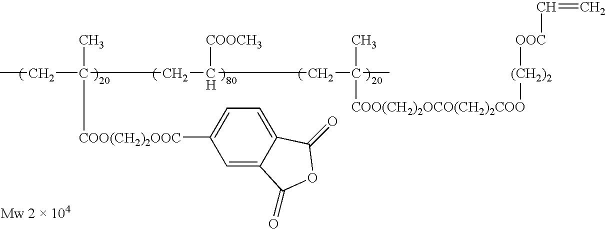 |
| 1-3 | PL1-3 | composite oxide of titanium and zirconium; content of Ti: 0.82 | Co ion 2.5% | 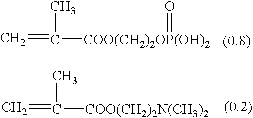 |
| 1-4 | PL1-4 | composite oxide of titanium and tin; content of Ti: 0.90 | Zr ion 1.0% | 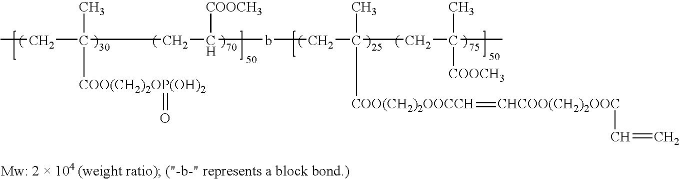 |

Evaluation of the properties of the thus-obtained antireflection films in the same manner as in Example 1-1 showed the same as, or more than, the properties of films obtained in Example 1-1.

### Example 2-1

(Formation of Hard Coat Layer)

125 g of a poly-functional acrylate monomer of DPHA and 125 g of a urethane acrylate oligomer UV-6300B (made by Nihon Gosei Kagaku K.K.) were dissolved in 439 g of industrial denatured alcohol. To the resultant solution was added a solution of 7.5 g of Irgacure 907 and 5.0 g of Kayacure DETX in 49 g of methyl ethyl ketone. After stirring the mixture, it was filtered through a polypropylene-made filter of 1 μm in pore size.

The resultant coating solution for forming a hard coat layer was coated on the triacetyl cellulose film of TAC-TD80U using a bar coater, followed by drying at 120° C. Subsequently, the coated layer was irradiated with UV rays to form a 7.5 μm-thick hard coat layer.

(Preparation of a Dispersion of Composite Oxide Fine Particles (PL2-1))

38.6 g of a dispersing agent of the following structure and 704.3 g of cyclohexanone were added to 257.1 g of composite oxide comprising titanium and bismuth [Ti/(Ti+Bi)=0.95 in molar ratio] (P-2), followed by dispersing in dynomil to prepare a dispersion of high refractive index fine particles of 55 nm in weight-average particle size.
Dispersing Agent

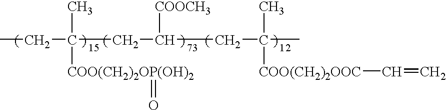

Mw: 1.5×10⁴ (weight ratio)

(Preparation of a Coating Solution for Middle Refractive Index Layer)

58.4 g of a poly-functional acrylate of DPHA, 3.1 g of Irgacure 907, 1.1 g of Kayacure DETX, 482.4 g of methyl ethyl ketone and 1869.8 g of cyclohexanone were added to 88.9 g of the above-described dispersion of high refractive index composite oxide fine particles (PL2-1), followed by stirring. The stirred mixture was filtered through a filter made of polypropylene of 0.4 μm in pore size to prepare a coating solution for a middle refractive index layer.

(Preparation of a Coating Solution (PL2-1) for High Refractive Index Layer)

22.3 parts by weight of tetraethoxysilane and 77.9 parts by weight of γ-glycidoxypropylmethyldiethoxysilane were added to a glass-made vessel equipped with a magnetic stirrer and, while keeping the solution temperature at 5 to 10° C. under stirring, 36.8 parts by weight of 0.01N hydrochloric acid was dropwise added thereto over 3 hours. After completion of the dropwise addition, stirring was conducted for 0.5 hour to obtain a partial hydrolyzate of tetraethoxysilane and γ-glycidoxypropylmethyldiethoxysilane. Subsequently, 397.8 parts by weight of the dispersion of high refractive index composite oxide fine particles (PL2-1) (concentration: 30.5% by weight), 65 parts by weight of butyl cellosolve and, further as curing agents, 2.6 parts by weight of aluminum acetylacetonate and 0.5 part by weight of ammonium perchlorate were added to 137 parts by weight of the partial hydrolyzate of tetraethoxysilane and γ-glycidoxypropylmethyldiethoxysilane. After sufficient stirring, the stirred solution was filtered to prepare a coating solution (PL2-1) for forming a high refractive index layer.

(Preparation of an Antireflection Film)

The coating solution for middle refractive index layer was coated on the hard coat layer using a gravure coater. After drying at 100° C., the coated layer was irradiated with ultraviolet rays with an intensity of 550 mW/cm² and an irradiation amount of 600 mJ/cm² using a 240 W/cm air-cooled metal halide lump (made by Ai Graphics K.K), while purging the atmosphere with nitrogen so that the oxygen concentration of the atmosphere was kept at a level of 1.0% by volume or less, to thereby cure the coated layer. Thus, there was formed a middle refractive index layer (refractive index: 1.65; thickness: 67 nm).

On the middle refractive index layer was coated the coating solution (PL2-1) for high refractive index layer using a gravure coater. After drying at 100° C., the coated layer was heat-treated at 120° C. for 2 hours to cure the coated layer. Thus, there was formed a high refractive index layer (refractive index: 1.95; thickness: 107 nm).

On the high refractive index layer was formed a low refractive index layer (refractive index: 1.44; thickness 82 nm) according to the method described in Example 1 of JP-A-2000-241603 using the composition for the low refractive index layer also described therein. Thus, there was formed an antireflection film.

(Evaluation of the Antireflection Film)

The thus-prepared antireflection film was evaluated in absolutely the same manner as in Example 1-1. Results showed the same good properties as in Example 1-1.

### Example 2-2 to Example 2-4

Antireflection films were prepared in the same manner as in Example 2-1 except for using respective dispersions of high refractive index composite oxide fine particles (PL2-2 to PL2-4) in place of the dispersion of composite oxide fine particles (PL2-1).

Additionally, average particle size of dispersed particles in the dispersions of respective composite oxide fine particles (PL2-2 to PL2-4) was within a range of from 60 to 90 nm, and the particles showed good monodispersing properties.

TABLE 3

| | | | Doped | |
|---|---|---|---|---|
| | Dispersion | | Metal | |
| | of | Fine Particles | Ion: | |
| | Composite | of Composite | Doped | |
| | Oxide Fine | Oxide (weight | amount | |
| Example | Particle | ratio) | (wt %) | Dispersing Agent (weight ratio) |
| 2-2 | PL2-2 | composite oxide of titanium and Indium; content of Ti: 0.85 | Zr ion 1.2% | 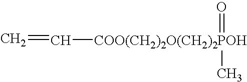 |
| 2-3 | PL2-3 | composite oxide of titanium and tantalum and aluminium; content of Al: 0.05 content of Ti: 0.82 | Zr ion 1.0% | 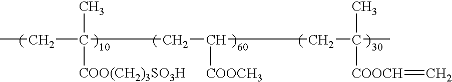 |
| 2-4 | PL2-4 | composite oxide of titanium and tantalum; content of Ti: 0.90 | Co ion 1.5% | 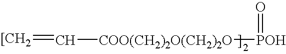 |

Evaluation of the properties of the thus-obtained antireflection films in the same manner as in Example 2-1 showed the same properties of films obtained in Example 2-1.

### Example 3

(Preparation of a Dispersion of High Refractive Index Composite Oxide Fine Particles))

A mixture of 92 g of fine particles of a composite oxide of Ti and Ta [Ti/(Ti+Ta)=0.8 in molar ratio] (P-3) doped with a cobalt ion (doping amount: 4% by weight), 31 g of a titanium-containing compound of the following structure and 337 g of cyclohexanone were finely dispersed in a sand mill (¼G sand mill) at 1600 rpm for 6 hours. As media, 1 mmΦ zirconia beads were used. Then, 0.1 g of 1N hydrochloric acid was added thereto, and the mixture was heated to 80° C. under a nitrogen atmosphere. Stirring was conducted for 4 hours. The particle size of the resultant surface-treated fine particles of doped composite oxide was 60 nm.

<Titanium-Containing Compound>
CH₂═CHCOO(CH₂₎₄Ti(OC₂H₅)₃

(Preparation of a Dispersion Solution for High Refractive Index Layer)

28.8 g of DPHA, 19.1 g of a polymerizable compound having the following structure, 2.4 g of Irgacure 907, 0.8 g of Kayacure DETX, 1.9 g of a sulfonium compound having the following structure, 455.8 g of methyl ethyl ketone and 1427.8 g of cyclohexanone were added to 586.8 g of the above-described dispersion of composite oxide fine particles (PL3-1), followed by stirring. The stirred mixture was filtered through a polypropylene-made filter of 0.4 μm in pore size to prepare a coating solution for a high refractive index layer.
<Polymerizable Compound> 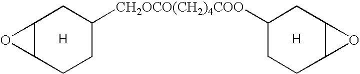
<Sulfonium Compound>

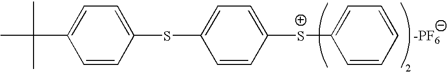

(Preparation of a Dispersion for a Stainproofing Layer)

Isopropyl alcohol was added to a thermally cross-linkable, fluorine-containing polymer (JN-7214; made by Nihon Gosei Gomu K.K.) to prepare a 0.6% by weight coarsely dispersed dispersion. This coarse dispersion was treated with ultrasonic wave to pared to finely disperse, thus a coating solution for a stainproofing layer being prepared.

(Preparation of an Antireflection Film)

A 80 μm-thick cellulose acylate film was prepared according to the method described in Example 1 of JP-A-151936. On this transparent support were formed the hard coat layer and the middle refractive index layer described in Example 1. On the middle refractive index layer was coated the coating solution for a high refractive index layer having prepared above using a gravure coater. After drying at 100° C., the coated layer was irradiated with ultraviolet rays with an intensity of 550 mW/cm² and an irradiation amount of 600 mJ/cm² using a 240 W/cm air-cooled metal halide lump (made by Ai Graphics K.K), while purging the atmosphere with nitrogen so that the oxygen concentration of the atmosphere was kept at a level of 1.0% by volume or less, then heated at 100° C. for 10 minutes to thereby cure the coated layer. Thus, there was formed a high refractive index layer (refractive index: 1.94; thickness: 105 nm).

On the high refractive index layer was formed a 88 nm-thick silica film (refractive index: 1.46) according to a vacuum deposition method. On the low refractive index layer was coated the coating solution for a stainproofing layer using a #3 wire bar, followed by drying at 120° C. for 1 hour. On the low refractive index layer of the antireflection film was coated the coating solution for an overcoat layer using a #3 wire bar, followed by drying at 120° C. for 1 hour to prepare an antireflection film.

Evaluation of the properties of the thus-obtained antireflection film in the same manner as in Example 1-1 showed the same good results as in Example 1-1 with respect to every property.

(Evaluation of an Image Display Device)

An image display device having the thus-prepared antireflection film of the invention was excellent in antireflection performance and gave extremely excellent visibility.

### Example 4

(Preparation of a Protecting Film for a Polarizing Plate)

(Preparation of a Polarizing Plate)

A 75 μm-thick polyvinyl alcohol film (made by Kurary Co., Ltd.) was dipped for 5 minutes in an aqueous solution composed of 1000 g of water, 7 g of iodine and 105 g of potassium iodide to adsorb iodine. Subsequently, this film was uniaxially stretched 4.4 times in a longitudinal direction in a 4% by weight boric acid aqueous solution and, while maintaining the stretched state, it was dried to prepare a polarizing film.

The antireflection film of the invention (protective film for the polarizing plate) was laminated on one side of the polarizing film, with the saponification-treated triacetyl cellulose surface facing the antireflection film using a polyvinyl alcohol series adhesive as an adhesive. Further, on the other side of the polarizing film was laminated a cellulose acylate film (TD-80UF) having been saponification-treated in the same manner as described above, using the same polyvinyl alcohol series adhesive.

(Evaluation of an Image Display Device)

A transmission type, reflection type or semi-transmission type liquid crystal display device of TN, STN, IPS, VA or OCB mode having the thus-prepared polarizing plate of the invention was excellent in antireflecting ability and extremely excellent in visibility.

### Example 5

(Preparation of a Polarizing Plate)

With an optically compensation film (Wide View Film SA-12B; made by Fuji Photo Film Co., Ltd.) having an optically anisotropic layer wherein the disc plane of discotic structural unit is inclined with respect to the transparent support plane and wherein the angle between the disc plane of the discotic structural unit and the transparent support plane changes in the depth direction of the optically anisotropic layer, the opposite surface to the optically anisotropic side was saponification-treated under the same conditions as in Example 4.

The saponification-treated triacetyl cellulose surface of the antireflection film (protective film for a polarizing plate) prepared in Example 4 was laminated on one surface of the polarizing film using a polyvinyl alcohol series adhesive as an adhesive. Further, on the other side of the polarizing film was laminated a saponification-treated triacetyl cellulose surface of the optically compensation film using the same polyvinyl alcohol series adhesive.

(Evaluation of an Image Display Device)

A transmission type, reflection type or semi-transmission type liquid crystal display device of TN, STN, IPS, VA or OCB mode having the thus-prepared polarizing plate of the invention was better than a liquid crystal display device having an optically compensation film-free polarizing plate in contrast in a bright room, provides an extremely wide upper, lower, left and right viewing angles and, further, shows an extremely excellent antireflecting performance, thus being extremely excellent in visibility and display quality.

### Example 6-1

(Preparation of a Coating Solution for Hard Coat Layer)

450.0 g of a dispersion of silica fine particles in methyl ethyl ketone (MEK-ST; content of solid component: 30% by weight; made by Nissan Kagaku K.K.), 15.0 g of methyl ethyl ketone, 220.0 g of cyclohexanone and 16.0 g of a photo polymerization initiator (Irgacure 907; made by Nihon Ciba Geigy K.K.) were added to 315.0 g of a mixture of dipentaerythritol pentaacrylate and dipentaerythritol hexaacrylate (DPHA; made by Nihon Kayaku K.K.), and the resulting mixture was stirred. The stirred mixture was filtered through a polypropylene-made filter of 0.4 μm in pore size to prepare a coating solution for a hard coat layer.

(Preparation of a Dispersion of Composite Oxide Fine Particles (PL11-1))

257 g of titanium/bismuth composite oxide having been surface-treated with aluminum oxide and stearic acid [Bi/(Ti+Bi)=0.05 in molar ratio] (content of the composite oxide: 85%) (P-1), 38.6 g of a dispersing agent of the following structure, 2.6 g of a cationic acrylate, DMAEA (made by K.K. Kojin) and 700 g of cyclohexanone were subjected to dispersing procedure in dynomil together with zirconia beads of 0.2 mm in particle size (YTZ balls made by K.K. Nikkato). The dispersing procedure was conducted at a temperature of 35 to 40° C. for 8 hours. The beads were separated away by using a 200-mesh nylon cloth to prepare a dispersion of the composite oxide fine particles (PL11-1).

The particle size of the dispersed particles of the thus-obtained dispersion was measured by a scanning type electron microscope to find that the particles were particles having good monodisperse properties and having an average particle size of 80 nm.

Also, measurement of the particle size distribution of the dispersion (using an apparatus for measuring particle size of scattered particles based on laser analysis; LA-920; made by Horiba Seisakusho) revealed that the content of particles of 500 nm or more in particle size was 0%.
Dispersing Agent

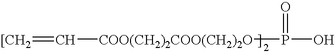

Also, when properties of the resultant dispersion were examined after leaving for one month, it was found that no precipitation was observed in the dispersion, that the particle size of the dispersed particles was the same as the size before one month, and that the content of 500 nm or more remained 0%.

(Preparation of a Coating Solution for Middle Refractive Index Layer)

58.4 g of DPHA, 3.1 g of Irgacure 907, 1.1 g of a photo sensitizing agent (Kayacure DETX, made by Nihon Kayaku K.K.), 482.4 g of methyl ethyl ketone and 1869.8 g of cyclohexanone were added to 88.9 g of the above-described dispersion of composite oxide fine particles (PL11-1), followed by stirring. The stirred mixture was filtered through a filter made of polypropylene of 0.4 μm in pore size to prepare a coating solution for a middle refractive index layer.

(Preparation of a Coating Solution for High Refractive Index Layer)

47.9 g of DPHA, 4.0 g of Irgacure 907, 1.3 g of Kayacure DETX, 455.8 g of methyl ethyl ketone and 1427.8 g of cyclohexanone were added to 586.8 g of the above-described dispersion of composite oxide fine particles (PL11-1), followed by stirring. The stirred mixture was filtered through a filter made of polypropylene of 0.4 μm in pore size to prepare a coating solution for a high refractive index layer.

(Preparation of a Coating Solution for Low Refractive Index Layer)

The solvent of a thermally cross-linkable, fluorine-containing polymer of 1.42 in refractive index (Opster JN7228; content of solid components: 6% by weight; made by JSR K.K.) was replaced to obtain a solution of the thermally cross-linkable, fluorine-containing polymer in methyl isobutyl ketone having a solid component concentration of 10% by weight. To 56.0 g of the thermally cross-linkable, fluorine-containing polymer solution were added 8.0 g of a dispersion of silica fine particles in methyl ethyl ketone (MEK-ST; content of solid component: 30% by weight; made by Nissan Kagaku K.K.), 1.75 g of the following silane compound, 73.0 g of methyl isobutyl ketone and 33.0 g of cyclohexanone, followed by stirring. The stirred mixture was filtered through a filter made of polypropylene of 0.4 μm in pore size to prepare a coating solution for a low refractive index layer

(Preparation of a Silane Compound)

161 g of 3-acryloxypropyltrimethoxysilane (KBM-5103; made by Shin-etsu Kagaku Kogyo K.K.), 123 g of oxalic acid and 415 g of ethanol were added to a reactor equipped with a stirrer and a reflux condenser and, after reacting at 70° C. for 4 hours, the reaction mixture was cooled to room temperature to obtain a silane compound as a curable composition. The weight-average molecular weight was 1600, and the content of a component of 1000 to 20000 in molecular weight based on the oligomer component was 100%. Analysis of gas chromatography revealed that the starting acryloxypropyltrimethoxysilane did not remain at all.

(Preparation of an Antireflective Film)

The coating solution for hard coat layer was coated on a 80 μm-thick triacetyl cellulose film (TD-80UF; made by Fuji Photo Film Co., Ltd.) using a gravure coater. After drying at 100° C., the coated layer was irradiated with ultraviolet rays with an intensity of 400 mW/cm² and an irradiation amount of 300 mJ/cm² using a 160 W/cm air-cooled metal halide lump (made by Ai Graphics K.K), while purging the atmosphere with nitrogen so that the oxygen concentration of the atmosphere was kept at a level of 1.0% by volume or less, to thereby cure the coated layer. Thus, there was formed a 3.5 μm-thick hard coat layer.

On the hard coat layer was coated the coating solution for middle refractive index layer using a gravure coater. After drying at 100° C., the coated layer was irradiated with ultraviolet rays with an intensity of 550 mW/cm² and an irradiation amount of 600 mJ/cm² using a 240 W/cm air-cooled metal halide lump (made by Ai Graphics K.K), while purging the atmosphere with nitrogen so that the oxygen concentration of the atmosphere was kept at a level of 1.0% by volume or less, to thereby cure the coated layer. Thus, there was formed a middle refractive index layer (refractive index: 1.65; thickness: 67 nm).

On the middle refractive index layer was coated the coating solution for high refractive index layer using a gravure coater. After drying at 100° C., the coated layer was irradiated with ultraviolet rays with an intensity of 550 MW/cm² and an irradiation amount of 600 mJ/cm² using a 240 W/cm air-cooled metal halide lump (made by Ai Graphics K.K), while purging the atmosphere with nitrogen so that the oxygen concentration of the atmosphere was kept at a level of 1.0% by volume or less, to thereby cure the coated layer. Thus, there was formed a middle refractive index layer (refractive index: 1.96; thickness: 105 nm).

On the high refractive index layer was coated the coating solution for low refractive index layer using a gravure coater. After drying at 80° C., the coated layer was irradiated with ultraviolet rays with an intensity of 550 mW/cm² and an irradiation amount of 600 mJ/cm² using a 160 W/cm air-cooled metal halide lump (made by Ai Graphics K. K) and heated at 120° C. for 10 minutes, while purging the atmosphere with nitrogen so that the oxygen concentration of the atmosphere was kept at a level of 1.0% by volume or less, to thereby form a low refractive index layer (refractive index: 1.43; thickness: 86 nm). Thus, there was formed an antireflective film.

### Example 6-2

(Preparation of a Dispersion of Composite Oxide Fine Particles)

257 g of the surface-treated composite oxide fine particles (P-1) used in Example 6-1, 40 g of a polymer dispersing agent of the following structure and 702 g of cyclohexanone were added and dispersed in dynomil together with zirconia beads of 0.2 mm in particle size. The dispersing procedure was conducted at a temperature of 35 to 40° C. for 5 hours. Thus, there was prepared a dispersion of composite oxide fine particles (PL11-2) of 65 nm in average particle size containing 0% of particles having a particle size of 500 nm.
Polymer Dispersing Agent:

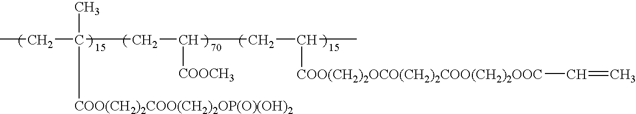

Mw=2×10⁴ (composition ratio by weight)

Also, when properties of the resultant dispersion were examined after leaving for one month, it was found that no precipitation was observed in the dispersion, that the particle size of the dispersed particles was the same as the size before one month, and that the content of 500 nm or more remained 0%.

An antireflective film was prepared in the same manner as in Example 6-1 except for using the above-described dispersion (PL11-2) of composite oxide fine particles in place of the dispersion (PL1-1) of composite oxide.

### Comparative Example 6-A

A dispersion was prepared in the same manner as with the dispersion (PL11-1) of the composite oxide in Example 6-1 except for using glass beads of 1.0 mm in size in place of the glass beads of 0.2 mm in size. The dispersed particles in the resultant dispersion had an extremely wide particle size distribution and had an average particle size of about 250 nm. Also, the proportion of particles of 500 nm or more was 10% by volume or more.

An antireflective film was prepared in the same manner as in Example 6-1 using the above-described dispersion in place of the composite oxide dispersion (PL11-1).

### Comparative Example 6-B

An antireflective film was prepared absolutely in the same manner as in Example 6-1 except for using titanium dioxide fine particles having been surface-treated with aluminum oxide and stearic acid (TTO-51 (C); content of titanium oxide: 79 to 85%; made by Ishihara Sangyo K.K.) in place of the composite fine particles (P-1) used in Example 6-1.

However, the coating solution for high refractive index layer was prepared by changing the weight ratio of the inorganic fine particles/DPHA so that the refractive index of the antireflective film prepared in the same manner as in Example 6-1 became the same (1.96) as that in Example 6-1. The weight ratio of the inorganic fine particles/DPHA was changed from 60/40 to 69/31, with the amount of the particles being increased.

### Comparative Example 6-C

Fine particles of bismuth (Bi₂O₃) were used in place of composite oxide fine particles used in Example 6-1. Except for this, the same procedure as in Example 6-1 was conducted to prepare an antireflective layer.

However, the coating solution for high refractive index layer was prepared by changing the weight ratio of the inorganic fine particles/DPHA so that the refractive index of the antireflective film prepared in the same manner as in Example 6-1 became the same (1.96) as that in Example 6-1. The weight ratio of the inorganic fine particles/DPHA was changed from 60/40 to 73/27, with the amount of the particles being increased.

(Evaluation of the Antireflective Film)

Each of the thus-prepared antireflective films was evaluated on the following items. Results are tabulated in Table 4.

(1) Evaluation of Haze

The haze of each antireflective film was evaluated using a haze meter (NHD-1001DP; made by Nihon Denshoku Kogyo K.K.).

(2) Evaluation of Reflectivity

The spectral reflectivity was measured at an incident angle of 50 in a wavelength region of 380 to 780 nm using a spectrophotometer (V-550, ARV-474; made by Nihon Bunko K.K.). An average refractivity in a wavelength range of 450 to 650 nm was determined.

(3) Whitening Test

A whitening test was conducted under the conditions of sun shine carbon arc lamp in light source, 60% in relative humidity, and 100 hours in testing period using a sunshine weather meter (S-80; made by Suga Shikenki K.K.). The whitening degree of the antireflective film before and after the exposure was observed and evaluated according to the following three grades:

A: No whitening was observed visually.

B: Whitening was visually observed a little.

C: Serious whitening was observed visually.

(4) Evaluation of Adhesion

Each of the antireflective films having been exposed in the test (3) was subjected to moisture conditioning under the conditions of 25° C. in temperature and 60% in relative humidity.

Notches were formed in a lattice pattern on the surface of the high refractive index layer side of each antireflective film using a cutter knife, with 11 notches in the longitudinal directions and 11 notches in the transverse directions, thus forming a total of 100 square areas surrounded by the notches, and an adhesion test using a polyester-made adhesive tape made by Nitto Denko K.K. (NO. 31B) was repeatedly conducted 3 times at the same position. Occurrence of delamination was visually observed and evaluated according to the following 4 grades:

◯◯: Absolutely no delamination was observed with the 100 pieces.

◯: Delamination was observed with 2 or less pieces out of 100 pieces.

Δ: Delamination was observed with 10 to 3 pieces out of 100 pieces.

X: Delamination was observed with more than 10 pieces out of 100 pieces.

(5) Evaluation of Pencil Hardness

After subjecting the antireflective films before and after the exposure were subjected to moisture conditioning under the conditions of 25° C. in temperature and 60% in relative humidity, and were evaluated in terms of pencil hardness under a load of 1 kg according to the evaluating method for pencil hardness described in JIS K5400 using a testing pencil specified by JIS S6006.

(6) Evaluation of Resistance to Scratching with Steel Wool

The state of scratches, formed when the antireflective films before and after the exposure were scratched 50 reciprocations by #0000 steel wool under a load of 500 g/cm2, was observed and evaluated according to the following three grades:

A: Absolutely no scratches was formed.

B: Scratches were formed a little, though difficult to observe.

C: Serious scratches were formed.

TABLE 4(A)

| | | Example | Example | Comparative |
|---|---|---|---|---|
| | | 6-1 | 6-2 | Ex. 6-A |
| Haze value | | 0.8% | 0.5% | 5% |
| Average reflectivity | | 0.3% | 0.25% | 1% |
| Whitening test | | A | A | A |
| Adhesion | Before exposure | ◯◯ | ◯◯ | Δ |
| | After exposure | ◯ | ◯ | Δ |
| Pencil | Before exposure | 3H | 3H | 2H to 3H |
| hardness | | | | (uneven) |
| | After exposure | 3H | 3H | 2H to 3H |
| | | | | (uneven) |
| Scratching | Before exposure | A | A | B |
| resistance | After exposure | A | A | B |

TABLE 4(B)

| | | Comparative | Comparative |
|---|---|---|---|
| | | Ex. 6-B | Ex. 6-C |
| Haze value | | 1.3% | — |
| | | | yellow-colored |
| Average reflectivity | | 0.38% | — |
| | | | yellow-colored |
| Whitening test | | C | A |
| Adhesion | Before exposure | ◯◯ | ◯ |
| | After exposure | X | ◯ |
| Pencil | Before exposure | 3H | 3H |
| hardness | After exposure | 1H or less | 3H |
| Scratching | Before exposure | A | A |
| resistance | After exposure | B | A |

The results shown in Table 4 shows the following facts.

Fresh films obtained in Examples 6-1 and 6-2 and Comparative Example 6-B before the exposure test were good in optical properties, adhesion, hardness and scratching resistance. On the other hand, the sample obtained in Comparative Example 6-A showed a large optical value. Further, it showed deteriorated adhesion, hardness and scratching resistance.

On the other hand, the sample obtained in Comparative Example 6-C comprising bismuth oxide alone suffered so serious yellow coloration of film that it was not practically usable as an antireflective film.

Further, film samples of Examples 6-1 and 6-2 after the weathering test showed almost the same good properties as the films before the weathering test. However, the sample obtained in Comparative Example 6-B suffered whitening of film and serious deterioration of film strength.

As is described hereinbefore, film samples of the invention showed extremely excellent weatherability and excellent optical properties and film strength.

Further, the contact angle of the surface of each of antireflective film prepared in Examples 6-1 and 6-2 of the invention for water was 101°, and the kinetic friction coefficient was 0.08. Measurement they were measured in the following manner.

(7) Evaluation of Contact Angle

Samples were subjected to moisture conditioning under the conditions of 25° C. in temperature and 60% in relative humidity for 2 hours. The contact angle of the surface of the antireflective film on the low refractive index layer side for water was evaluated.

(8) Evaluation of Kinetic Friction Coefficient

As an indicator for slipping property of the surface of the antireflective film on the low refractive index layer side, kinetic friction coefficient was evaluated. The kinetic fraction coefficient was measured under using a kinetic friction coefficient-measuring machine (HEIDON-14) and stainless steel ball of 5 mm in diameter under a load of 100 g at a speed of 60 cm/min after subjecting a sample to moisture conditioning under the conditions of 25° C. in temperature and 60% in relative humidity for 2 hours.

### Example 6-3 to Example 6-8

Antireflective films were prepared in the same manner as in Example 6-2 except for using respective dispersions of composite oxide fine particles (PL11-3 to PL11-8) in place of the dispersion of composite oxide fine particles (PL11-2).

Additionally, average particle size of dispersed particles in the dispersions of respective composite oxide fine particles (PL11-3 to PL11-8) was within a range of from 60 to 80 nm, and the particles showed good monodispersing properties.

TABLE 5

| | Dispersion | |
|---|---|---|
| | of | |
| | Composite | |
| | Oxide Fine | |
| Example | Particle | Dispersing Agent (weight ratio) |
| 6-3 | PL11-3 | 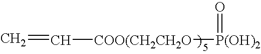 |
| 6-4 | PL11-4 | 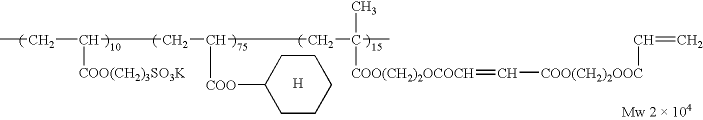 |
| 6-5 | PL11-5 | 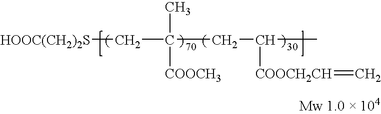 |
| 6-6 | PL11-6 | 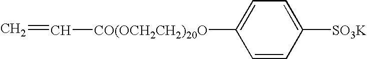 |
| 6-7 | PL11-7 | 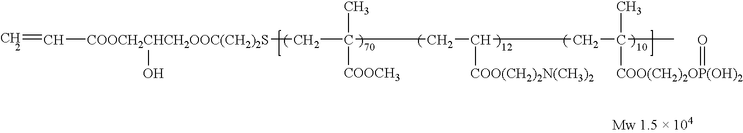 |
| 6-8 | PL11-8 | [CH₂═CH—COO(CH₂)₂O(CH₂)₂]₂N(CH₂)₃SO₃Na |

Evaluation of the properties of the thus-obtained antireflective films in the same manner as in Example 6-1 showed the same as, or more than, the properties of films obtained in Example 6-1.

### Example 7-1

(Formation of Hard Coat Layer)

125 g of a poly-functional acrylate monomer of DPHA and 125 g of a urethane acrylate oligomer UV-6300B (made by Nihon Gosei Kagaku K.K.) were dissolved in 439 g of industrial denatured alcohol. To the resultant solution was added a solution of 7.5 g of Irgacure 907 and 5.0 g of Kayacure DETX in 49 g of methyl ethyl ketone. After stirring the mixture, it was filtered through a polypropylene-made filter of 1 μm in pore size.

The resultant coating solution for forming a hard coat layer was coated on the triacetyl cellulose film of TAC-TD80U usingl a bar coater, followed by drying at 12°° C. Subsequently, the coated layer was irradiated with UV rays to form a 7.5 μm-thick hard coat layer.

(Preparation of a Dispersion of Composite Oxide Fine Particles (PL2-1))

38.6 g of a dispersing agent of the following structure and 704.3 g of cyclohexanone were added to 257.1 g of composite oxide comprising titanium, bismuth and aluminum [Bi/(Ti+Bi+Zr)=0.08 in molar ratio; Zr/Bi+Ti+Zr=0.05 in molar ratio] (P-2), followed by dispersing in dynomil together with zirconia beads of 0.3 mm in particle size. The dispersing procedure was conducted at a temperature of 40 to 45° C. for 6 hours to prepare a dispersion of composite oxide fine particles (PL2-1). The dispersed particles in the thus-obtained dispersion had an average particle size of 75 nm, with the content of particles of 500 nm or more being 0%.
Dispersing Agent

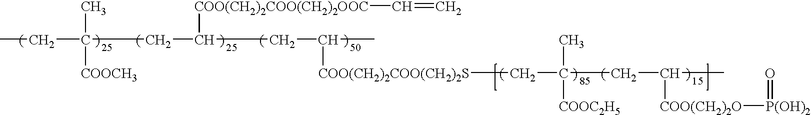

Mw: 4×10⁴ (Mw of graft moiety: 8×10³)

(Preparation of a Coating Solution for Middle Refractive Index Layer)

58.4 g of a poly-functional acrylate of DPHA, 3.1 g of Irgacure 907, 1.1 g of Kayacure DETX, 482.4 g of methyl ethyl ketone and 1869.8 g of cyclohexanone were added to 88.9 g of the above-described dispersion of composite oxide fine particles (PL2-1), followed by stirring. The stirred mixture was filtered through a filter made of polypropylene of 0.4 μm in pore size to prepare a coating solution for a middle refractive index layer.

(Preparation of a Coating Solution for High Refractive Index Layer)

22.3 parts by weight of tetraethoxysilane and 77.9 parts by weight of γ-glycidoxypropylmethyldiethoxysilane were added to a glass-made vessel equipped with a magnetic stirrer and, while keeping the solution temperature at 5 to 10° C. under stirring, 36.8 parts by weight of 0.1N hydrochloric acid was dropwise added thereto over 3 hours. After the dropwise addition, stirring was conducted for 0.5 hour to obtain a partial hydrolyzate of tetraethoxysilane and γ-glycidoxypropylmethyldiethoxysilane. Subsequently, 397.8 parts by weight of the dispersion of composite oxide fine particles (PL2-1) (concentration: 30.5% by weight), 65 parts by weight of butyl cellosolve and, further as curing agents, 2.6 parts by weight of aluminum acetylacetonate and 0.5 part by weight of ammonium perchlorate were added to 137 parts by weight of the partial hydrolyzate of tetraethoxysilane and γ-glycidoxypropylmethyldiethoxysilane. After sufficient stirring, the stirred solution was filtered to prepare a coating solution for forming a high refractive index layer.

(Preparation of an Antireflective Film)

The coating solution for middle refractive index layer was coated on the hard coat layer using a gravure coater. After drying at 100° C., the coated layer was irradiated with ultraviolet rays with an intensity of 550 mW/cm² and an irradiation amount of 600 mJ/cm² using a 240 W/cm air-cooled metal halide lump (made by Ai Graphics K.K), while purging the atmosphere with nitrogen so that the oxygen concentration of the atmosphere was kept at a level of 1.0% by volume or less, to thereby cure the coated layer. Thus, there was formed a middle refractive index layer (refractive index: 1.65; thickness: 67 nm).

On the middle refractive index layer was coated the coating solution for high refractive index layer using a gravure coater. After drying at 100° C., the coated layer was heat-treated at 120° C. for 2 hours to cure the coated layer. Thus, there was formed a high refractive index layer (refractive index: 1.95; thickness: 107 nm).

On the high refractive index layer was formed a low refractive index layer (refractive index: 1.44; thickness 82 nm) according to the method described in Example 1 of JP-A-2000-241603 using the composition for the low refractive index layer also described therein. Thus, there was formed an antireflective film.

(Evaluation of the Antireflective Film)

The thus-prepared antireflective film was evaluated in absolutely the same manner as in Example 6-1. Results are tabulated in Table 5.

TABLE 5

| | | Example 7-1 |
|---|---|---|
| Haze value | | 0.9% |
| Average reflectivity | | 0.4% |
| Whitening test | | A |
| Adhesion | Before exposure | ◯◯ |
| | After exposure | ◯ |
| Pencil | Before exposure | 3H |
| hardness | After exposure | 3H |
| Scratching | Before exposure | A |
| resistance | After exposure | A |

### Example 7-2 to Example 7-4

Antireflective films were prepared in the same manner as in Example 7-1 except for using respective dispersions of composite oxide fine particles (PL2-2 to PL2-4) in place of the dispersion of composite oxide fine particles (PL2-1).

Additionally, average particle size of dispersed particles in the dispersions of respective composite oxide fine particles (PL2-2 to PL2-4) was within a range of from 55 to 80 nm, and the particles showed good monodispersing properties.

TABLE 6

| | Dispersion | | |
|---|---|---|---|
| | of | Fine Particles | |
| | Composite | of Composite | |
| | Oxide Fine | Oxide (weight | |
| Example | Particle | ratio) | Dispersing Agent (weight ratio) |
| 7-2 | PL2-2 | composite oxide of bismuth and titanium having been surface-treated with cobalt oxalate [Bi/Bi + Ti = 0.07 in molar ratio](content: 82 wt %) | 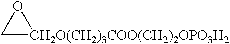 |
| 7-3 | PL2-3 | composite oxide of bismuth and tantalum; [Bi/Bi + Ta = 0.06 in molar ratio] | 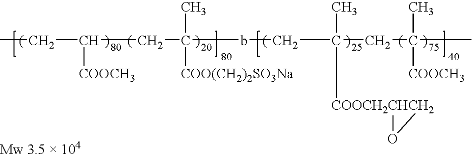 |
| 7-4 | PL2-4 | composite oxide of bismuth and zirconium; 0.04 [Bi/Bi + Zr = 0.04 in molar ratio] | 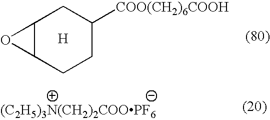 |

Evaluation of the properties of the thus-obtained antireflective films in the same manner as in Example 7-1 showed the same properties of films obtained in Example 7-1.

### Example 8

(Preparation of a Dispersion of Composite Oxide Fine Particles (PL3-1))

A mixture of 92 g of fine particles comprising a composite oxide of bismuth, zirconium and titanium [Bi/(Bi+Ti+Zr)=0.07 in molar ratio; Zr/Bi+Ti+Zr=0.05 in molar ratio] (P-3), 31 g of a titanium-containing compound of the following structure and 337 g of cyclohexanone were finely dispersed in a sand mill (¼G sand mill) at 1600 rpm for 6 hours. As media, zirconia beads of 0.2 mm in particle size was used. Then, 0.1 g of 1N hydrochloric acid was added thereto, and the mixture was heated to 80° C. under a nitrogen atmosphere. Stirring was conducted for 4 hours to prepare a dispersion of the composite oxide fine particles (PL-3). The particle size of the resultant surface-treated fine particles was 70 nm.
<Titanium-Containing Compound> 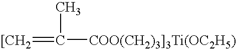
(Preparation of a Dispersion Solution for High Refractive Index Layer)

28.8 g of DPHA, 19.1 g of a polymerizable compound having the following structure, 2.4 g of Irgacure 907, 0.8 g of Kayacure DETX, 1.9 g of a sulfonium compound having the following structure, 455.8 g of methyl ethyl ketone and 1427.8 g of cyclohexanone were added to 586.8 g of the above-described dispersion of composite oxide fine particles (PL3-1), followed by stirring. The stirred mixture was filtered through a polypropylene-made filter of 0.4 μm in pore size to prepare a coating solution for a high refractive index layer.
<Polymerizable Compound> 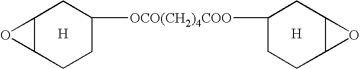
<Sulfonium Compound> 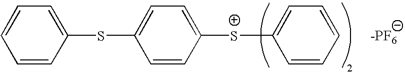
(Preparation of a Dispersion for a Stainproofing Layer)

Isopropyl alcohol was added to a thermally cross-linkable, fluorine-containing polymer (JN-7214; made by Nihon Gosei Gomu K.K.) to prepare a 0.6% by weight coarsely dispersed dispersion. This coarse dispersion was treated with ultrasonic wave to pared to finely disperse, thus a coating solution for a stainproofing layer being prepared.

(Preparation of an Antireflective Film)

A 80 μm-thick cellulose acylate film was prepared according to the method described in Example 1 of JP-A-151936. On this transparent support were formed the hard coat layer and the middle refractive index layer described in Example 6-1. On the middle refractive index layer was coated the coating solution for a high refractive index layer having prepared above using a gravure coater. After drying at 100° C., the coated layer was irradiated with ultraviolet rays with an intensity of 550 mW/cm² and an irradiation amount of 600 mJ/cm² using a 240 W/cm air-cooled metal halide lump (made by Ai Graphics K.K), while purging the atmosphere with nitrogen so that the oxygen concentration of the atmosphere was kept at a level of 1.0% by volume or less, then heated at 100° C. for 10 minutes to thereby cure the coated layer. Thus, there was formed a high refractive index layer (refractive index: 1.94; thickness: 105 nm).

On the high refractive index layer was formed a 88 nm-thick silica film (refractive index: 1.46) according to a vacuum deposition method. On the low refractive index layer was coated the coating solution for a stainproofing layer using a #3 wire bar, followed by drying at 120° C. for 1 hour. On the low refractive index layer of the antireflective film was coated the coating solution for an overcoat layer using a #3 wire bar, followed by drying at 120° C. for 1 hour to prepare an antireflective film.

Evaluation of the properties of the thus-obtained antireflective film in the same manner as in Example 6-1 showed the same good results as in Example 6-1 with respect to every property.

### Example 9

(Preparation of a Protective Film for a Polarizing Plate)

With the antireflective films prepared in Examples 6-1 to 6-8 and Examples 7-1 to 7-4, the surface of the transparent support on the opposite side to the high refractive index layer of the invention was subjected to an alkali saponification treatment in the following manner.

Each film was passed over a 60° C. dielectrically heating roll to raise the temperature of the film surface to 40° C., then an alkali solution (S) of the following composition was coated thereon in a coating amount of 15 cc/m² using a rod coater and, after keeping it for 15 seconds under a steam type far-infrared heater (made by Noritake Company Limited) heated to 110° C., pure water was coated thereon in an amount of 3 cc/m² similarly using the rod coater. The temperature of the film upon this was 40° C. Subsequently, a combination of washing with water using a fountain coater and hydro-extraction with an air-knife was repeated 3 times, then the film was kept in a 70° C. drying zone for 5 seconds to dry.

Composition of the Alkali Solution (S):

| | | |
|---|---|---|
| Potassium hydroxide | 8.55% | by weight |
| Water | 23.235% | by weight |
| Isopropanol | 54.20% | by weight |
| Surfctant (K-1; C₁₄H₂₉O(CH₂CH₂O)₂₀H) | 1.0% | by weight |
| Propylene glycol | 13.0% | by weight |
| Anti-foam agent (Surfinol DF110D; | 0.015% | by weight |
| made by Nissin Kagaku Kogyo K.K.) | | |

(Preparation of a Polarizing Film)

A 75 μm-thick polyvinyl alcohol film (made by Kuraray Co., Ltd.) was dipped in an aqueous solution comprising 100 g of water, 7 g of iodine and 105 g of potassium iodide for 5 minutes to adsorb iodine. Subsequently, this film was uniaxially stretched 4.4 times in a longitudinal direction in a 4% by weight boric acid aqueous solution and, while maintaining the stretched state, it was dried to prepare a polarizing film.

The antireflective film of the invention (protective film for the polarizing plate) was laminated on one side of the polarizing film, with the saponification-treated triacetyl cellulose surface facing the antireflective film, using a polyvinyl alcohol series adhesive as an adhesive. Further, on the other side of the polarizing film was laminated a cellulose acylate film (TD80UF) having been saponification-treated in the same manner as described above using the same polyvinylalcohol series adhesive.

(Evaluation of an Image Display Device)

A transmission type, reflection type or semi-transmission type liquid crystal display device of TN, STN, IPS, VA or OCB mode having the thus-prepared polarizing plate of the invention was excellent in antireflective performance and gave extremely excellent visibility.

### Example 10

(Preparation of a Polarizing Plate)

With an optically compensation film (Wide View Film SA-12B; made by Fuji Photo Film Co., Ltd.) having an optically anisotropic layer wherein the disc plane of discotic structural unit is inclined with respect to the transparent support plane and wherein the angle between the disc plane of the discotic structural unit and the transparent support plane changes in the depth direction of the optically anisotropic layer, the opposite surface to the optically anisotropic side was saponification-treated under the same conditions as in Example 9.

The saponification-treated triacetyl cellulose surface of the antireflective film (protective film for a polarizing plate) prepared in Example 9 was laminated on one surface of the polarizing film using a polyvinyl alcohol series adhesive as an adhesive. Further, on the other side of the polarizing film was laminated a saponification-treated triacetyl cellulose surface of the optically compensation film using the same polyvinyl alcohol series adhesive.

(Evaluation of an Image Display Device)

A transmission type, reflection type or semi-transmission type liquid crystal display device of TN, STN, IPS, VA or OCB mode having the thus-prepared polarizing plate of the invention was better than a liquid crystal display device having an optically compensation film-free polarizing plate in contrast in a bright room, provides an extremely wide upper, lower, left and right viewing angles and, further, shows an extremely excellent antireflecting performance, thus being extremely excellent in visibility and display quality.

### INDUSTRIAL APPLICABILITY

The antireflection film using a high refractive index layer composition containing fine particles of high refractive index composite oxide comprising specific elements is excellent in weatherability (particularly, resistance to light) and can be provided inexpensively on a large scale.

Further, the antireflection film having the above-described merits can be used in a polarizing plate or an image display device to provide images having excellent visibility and display quality.

Also, The antireflective film using a high refractive cured film formed from a coating composition containing ultrafine particles of high refractive index composite oxide comprising specific elements is excellent in weatherability (particularly, resistance to light) and can be provided inexpensively on a large scale.

Further, the antireflective film having the above-described merits can be used in a polarizing plate or an image display device to provide images having excellent visibility and display quality.

1. A high refractive index layer comprising a matrix and fine particles of a high refractive index composite oxide,
wherein the fine particles of a high refractive index composite oxide are fine particles of a composite oxide containing: a titanium element; and at least one metal element, in which the oxide of the at least one metal element has a refractive index of 1.95 or more, and
the composite oxide is doped with at least one metal ion selected from the group consisting of Co ion, Zr ion and Al ion.

2. The high refractive index layer as described in claim 1, wherein the fine particles of a high refractive index composite oxide are surface-treated with at least one compound of an inorganic compound and an organic compound.

3. The high refractive index layer as described in claim 2, wherein the matrix contains a cured product of at least one member selected from the group consisting of an organic binder, an organometallic compound and a partial hydrolyzate thereof.

4. The high refractive index layer as described in claim 1, which has a refractive index of 1.75 to 2.4.

5. The high refractive index layer as described in claim 1, which is formed from a composition obtained by dispersing particles of the high refractive index composite oxide using a dispersing agent, in which the dispersing agent is a compound having at least one anionic group selected from the group consisting of a carboxyl group, a sulfo group, a phosphono group and an oxyphosphono group.

6. The high refractive index layer as described in claim 5, wherein the dispersing agent is a compound containing a cross-linkable or polymerizable functional group.

7. An antireflection film comprising: a transparent support; the high refractive index layer described in claim 1; and a low refractive index layer having a refractive index of less than 1.55, in this order.

8. An antireflection film comprising a transparent support; two layers of the high refractive index layers described in claim 1 and different from each other in refractive index; and a low refractive index layer having a refractive index of less than 1.55, in this order.

9. The antireflection film as described in claim 8, which further comprises a hard coat layer between the transparent support and the high refractive index layer.

10. A polarizing plate comprising a polarizing film and a protective film thereof, wherein the protective film is the antireflection film described in claim 7.

11. A polarizing plate comprising a polarizing film and protective films thereof, wherein one of the protective films is the antireflection film described in claim 7, and the other protective film is an optically compensation film having an optical anisotropy.

12. The polarizing plate as described in claim 11, wherein said optically compensation film comprises a transparent support and an optically compensation layer including an optically anisotropic layer, the optically anisotropic layer containing a compound having a discotic structural unit, in which the disc plane of the discotic structural unit is inclined to the transparent support plane, and the angle between the disc plane and the transparent support plane is varied in the depth direction of the optically anisotropic layer.

13. An image display device comprising, on the image display surface, the antireflection film described in claim 7.

14. A process for producing a curable coating composition comprising a film-forming curable compound and fine particles of a high refractive index composite oxide, in which the fine particles of a high refractive index composite oxide contains: a bismuth element; and at least one metal element, in which the oxides of the at least one metal element has a refractive index of 1.95 or more,
wherein the process comprises wet-dispersing particles of the high refractive index composite oxide and a dispersing agent using media having an average particle size of less than 1 mm to thereby produce fine particles of high refractive index composite oxide having an average particle size of 150 nm or less.

15. The process as described in claim 14, wherein said dispersing agent is a polymer dispersing agent having a polar group.

16. The process as described in claim 15, wherein said polar group is an at least one anionic group selected from the group consisting of a carboxyl group, a sulfo group, a phosphono group and oxyphosphono group.

17. The process as described in claim 15, wherein said dispersing agent is a compound having a cross-linkable or polymerizable functional group.

18. The process as described in claim 14, wherein said film-forming curable compound is at least one of a curable organic binder, an organometallic compound and a partial hydrolyzate thereof.

19. A cured film which has a refractive index of 1.85 to 2.5 and is formed from a curable coating composition containing a film-forming curable compound and fine particles of a high refractive index composite oxide having an average particle size of 100 nm or less, the fine particles of a high refractive index composite oxide containing: a bismuth element; and at least one metal element, in which the oxide of the at least one metal element has a refractive index of 1.95 or more.

20. An antireflection film comprising: a transparent support; the cured film described in claim 19; and a low refractive index layer having a refractive index of less than 1.55, in this order.

21. An antireflection film comprising: a transparent support; two layers of the cured films described in claim 19 and different from each other in refractive index; and a low refractive index layer having a refractive index of less than 1.55, in this order.

22. The antireflection film as described in claim 20, which further comprises a hard coat layer between the transparent support and the cured film.

23. A polarizing plate comprising a polarizing film and a protective film thereof, wherein the protective film is the antireflection film described in claim 20.

24. A polarizing plate comprising a polarizing film and protective films thereof, wherein one of the protective films is the antireflection film described in claim 20 and the other protective film is an optically compensation film having an optical anisotropy.

25. The polarizing plate as described in claim 24, wherein said optically compensation film comprises a transparent support and an optically compensation layer including an optically anisotropic layer, the optically anisotropic layer containing a compound having a discotic structural unit, in which the disc plane of the discotic structural unit is inclined to the transparent support plane, and the angle between the disc plane and the transparent support plane is varied in the depth direction of the optically anisotropic layer.

26. An image display device comprising, on the image display surface, the antireflection film described in claim 20.

27. The high refractive index layer as described in claim 1, wherein the matrix contains a cured product of at least one member selected from the group consisting of an organic binder, an organometallic compound and a partial hydrolyzate thereof.

28. The antireflection film as described in claim 7, which further comprises a hard coat layer between the transparent support and the high refractive index layer.

29. An image display device comprising, on the image display surface, the polarizing plate described in claim 10.
